(19) United States
(12) Patent Application Publication
(10) Pub. No.: US 2019/0139166 A1
(43) Pub. Date: May 9, 2019

(54) SYSTEM FOR GENERATING AND MANAGING A CUSTOMIZED ONLINE TRAVEL PRODUCT

(71) Applicant: The Upside Commerce Group, LLC, Washington, DC (US)

(72) Inventors: Jay S. Walker, Stamford, CT (US); Timothy Scott Case, Washtington, DC (US); Emily Katherine Dresner, Laurel, MD (US); Timothy I.C. Fisher, Arlington, VA (US); Sofia K. Heisler, Washington, DC (US); Phillip Armour, Mclean, VA (US); Mark Hanson, Washington, DC (US)

(21) Appl. No.: 16/241,990

(22) Filed: Jan. 8, 2019

Related U.S. Application Data
(63) Continuation of application No. PCT/US2017/041413, filed on Jul. 10, 2017.
(60) Provisional application No. 62/446,525, filed on Jan. 15, 2017.
(60) Provisional application No. 62/360,318, filed on Jul. 9, 2016.

(51) Int. Cl. G06Q 50/14; G06Q 10/02; G06Q 50/12; G06Q 30/02

(52) U.S. Cl. CPC G06Q 50/14; G06Q 30/0207; G06Q 50/12; G06Q 10/02

(57) ABSTRACT

In accordance with some embodiments, a system is operable to generate at least two alternative travel packages to offer to a user, each travel package being defined by a distinct value for each of: (i) a first component of the travel package; (ii) a second component of the travel package; (iii) a price of the travel package; (iv) an amount of savings to be realized by purchasing the travel package; and (v) a value of a reward to be provided to the user in exchange for purchasing the travel package. In accordance with one embodiment, one of the offered travel packages is within an initial scope of the user's preferred itinerary and offers a relatively lower value of reward to the user while another of the offered travel packages is outside the initial scope and offers a relatively higher value of reward.

This application is a Continuation Application of PCT Application No. PCT/US17/41413, filed on Jul. 10, 2017 in the name of Jay S. Walker and titled SYSTEM FOR GENERATING AND MANAGING A CUSTOMIZED ONLINE TRAVEL PRODUCT, which PCT Application claims the benefit of (i) U.S. Provisional Patent Application No. 62/360,318, filed on Jul. 9, 2016 in the name of Walker et al. and titled SYSTEM FOR GENERATING AND MANAGING A CUSTOMIZED ONLINE TRAVEL PRODUCT; and (ii) U.S. Provisional Application No. 62/446,525 filed Jan. 15, 2017 in the name of Walker et al., titled SYSTEM FOR GENERATING AND MANAGING A CUSTOMIZED ONLINE TRAVEL PRODUCT. The entirety of each of these Applications is incorporated by reference herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### INTRODUCTION

Applicant has invented a system for generating and managing a travel service product that seeks to align the interests of a traveler (e.g., a business traveler) and a third party (e.g., an employer of the traveler), such as by providing incentives or rewards to the traveler that motivate the traveler to select travel options that the traveler may not otherwise agree to but that are beneficial to the third party (e.g., travel options that are less convenient to the traveler but that result in a cost savings for the employer). In accordance with some embodiments, the traveler is rewarded with monetary incentives or rewards (e.g., free gift cards) for selecting a broader range of acceptable options or providing flexibility (e.g., in terms of travel dates/times, acceptable hotels, class of seating options, airports, etc.) for their upcoming travel booking. In accordance with some embodiments, based on the traveler's trip requirements and flexibility boundaries, the system dynamically creates a travel package (e.g., air and hotel reservations, air and ground transportation services, etc.) that is less expensive yet less convenient than alternate packages the traveler may otherwise book via standard retail providers of such services. The cost savings may be provided exclusively to the traveler (e.g., in the form of gift cards, a discounted price or other monetary incentives), exclusively to the employer (e.g., in the form of less expensive travel package that the employer will eventually reimburse the traveler for or that the employer may otherwise pay for) or apportioned among the traveler and the employer (e.g., 50/50, 70/30 or any other desirable split).

In accordance with some embodiments, the system calculates or determines a spread or difference between (i) what a travel package would have cost (e.g., by summing the publicly available retail prices (or an average or median of such retail prices, for each component of the travel package) and (ii) the cost of the travel package if purchased through the system. The system may then utilize an algorithm to allocate this spread or difference among (i) a value of an incentive to be provided to the online traveler (e.g., in the form of discounts or other reward); (ii) a value of savings to be realized by a third party such as an employer or hirer of the online traveler; and (iii) a value of profit to be realized by the system as a result of selling the package to the online traveler. In some embodiments, the spread or difference may be determined based on a value of incentives used to generate the package, such as discounts offered to the system by providers of the services comprising the components of the system (e.g., discounted rates offered by hotels or airlines to the system) or other incentives offered to the system by other entities (e.g., a restaurant in a hotel may offer to subsidize a traveler's stay at a hotel in which the restaurant is located, in an attempt to draw customers to its restaurant).

In accordance with some embodiments, the traveler's trip requirements and range of flexibility for certain trip parameters (e.g., number of stops, acceptable areas of destination city for hotel, time of travel, class of airline seat) may be obtained from the player via a series of questions, some of which offer monetary incentive to the customer in exchange for the customer's agreement to define and/or accept options or component variables within a broader scope than what the traveler has initially indicated as preferable for certain parameters or components of the trip. For example, the system may attempt to motivate (e.g., through monetary incentives) the traveler to accept a different hotel (e.g., a hotel that is in a different location of a city or of a lower rating) than what the customer initially indicates as his preference. In accordance with some embodiments, the system may be programmed to motivate the traveler to select travel options that are less than what the traveler may otherwise be entitled to based on his employer's travel policies or preferences (e.g., a 3 star hotel rather than a 4 star hotel, economy class airline seat rather than a business class airline seat) or agree to flexibility (e.g., to fly on 1 of any 3 airlines, leave from either of 2 airports, etc.) in exchange for rewards (e.g., gift card value). The system may be programmed to use monetary or other incentives to try and steer the traveler towards inventory prioritized in the system (e.g., hotels and airlines that have given preferential rates to the system for certain geographical areas, times or types of travelers).

In accordance with some embodiments, the system utilizes a filtering methodology to filter out potential components or options to include in one or more travel packages to be offered to the customer (e.g., filtering out options or components that the system determines are unlikely to appeal to the customer and thus should not be included in a travel package offered to the customer). For example, the system may determine that certain options or parameter values are so far out of the scope of what the traveler is indicating as his preferences that they are unlikely to be accepted by the traveler even with monetary incentives. In accordance with some embodiments, the system utilizes a scoring methodology to score various options or components (e.g., assigning a score on a scale of (+1_to (−1) to each option or component) and then generates a travel package using the results of the scoring methodology. In accordance with some embodiments, either the filtering or scoring methodology may be based on (i) data comprising the customer's answers to questions, feedback from the customer based on previously accepted or rejected travel package offers or other input received from the customer; (ii) data derived from previous behavior, purchases or travel history of the customer; (iii) data derived from purchases, travel history or feedback from other customers; (iv) reward incentives available from third party vendors; or (v) other data deemed to be relevant to the system's determinations.

In some embodiments, the system may be programmed to value, rate or score a customer's flexibility on certain trip parameters. The employer benefits by having its employees book less expensive travel packages than they otherwise would have booked (based on the employer's travel policies). Thus, even in scenarios in which the traveler collects all the “upside” or incentives in the form of gift cards and doesn't split it with the employer (e.g., by having some of the incentives provided to the employer in the form of a further discounted price), the travel packages booked through the system will still be less expensive than what the traveler was otherwise entitled to book based on the employer's travel policies and thus the employer benefits. It should be noted that the terms “traveler”, “online traveler”, “user” and “customer” may all be used interchangeably herein to refer to an entity that utilized or is utilizing the travel package service described herein to request, consider or purchase a travel package (although the term user may refer to other types of entities as well, depending on the context).

Currently travel products are identified by customers using search and find methodologies; the innovative embodiments described herein utilize a software engine designed to capture and pro-actively maximize a traveler's flexibility by providing financial incentives to the customer, in order to dynamically create a travel product package (e.g., airfare and hotel) that meets the criteria of the traveler's flexibility while maximizing cost savings for the package. The system described herein is, in accordance with some embodiments, programmed to calculate a value on the customer's flexibility with respect to particular parameters (and value choices for the parameters) of a trip, output offers to the customer based on such calculations in order to obtain from the customer the boundaries of the customer's flexibility and then dynamically create a travel package for the customer based on the customer's trip requirements and boundaries of the customer's flexibility. In some embodiments, in order to maintain the price integrity for airlines and hotels and prevent the appearance of price dilution, a customer may be required to agree to some minimum level of flexibility when booking a package through the system (e.g., any one of three specified airlines and any one of three specified hotels are acceptable for creation of a package).

Although various embodiments described herein are described with respect to travel packages that include airfare and hotel, similar methodologies may be utilized to value and maximize a customer's flexibility for purchases in other industries (e.g., groceries, mortgages, cars, electronics, healthcare, etc.). Additionally, although various embodiments described herein are illustrated with reference to packages of multiple products, many of the features and processes described herein may be implemented for an a la carte service that allows travelers to purchase individual components or products (e.g., just a flight or just a hotel room). For example, the system may provide options to a traveler for either different hotel bookings or different flights (not as a package but as individual a la carte menu options), wherein the traveler is offered incentives, savings or rewards of varying degrees based on the particular hotel or flight.

Certain aspects, advantages, and novel features of various embodiments are described herein. It is to be understood that not necessarily all such advantages may be achieved in accordance with any particular embodiment of the invention(s) described. Thus, for example, those skilled in the art will recognize that embodiments described herein may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention(s) described herein extend(s) beyond the specifically disclosed embodiments, examples and illustrations and includes other uses of the invention(s) and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

### BRIEF DESCRIPTION OF THE FIGURES

Features, aspects and advantages of various embodiments are described in detail below with reference to the accompanying drawings, which are intended to illustrate and not to limit the embodiments. The drawings comprise the following figures in which:

FIG. 1 is a schematic diagram of an embodiment of a system in accordance with one or more embodiments described herein.

FIG. 2 is a block diagram of an embodiment of a computing device useful in a system according to one or more embodiments described herein.

FIG. 3 is a block diagram of example conceptual architecture for a travel package generation engine, as may be included in the computing system of FIG. 1 and/or FIG. 2.

FIG. 4 is a block diagram of an embodiment of a system in accordance with one or more embodiments described herein.

FIG. 5 is a flow chart diagram of an example process in accordance with one or more embodiments described herein.

FIG. 6 is a flow chart diagram of an example process in accordance with one or more embodiments described herein.

FIG. 7 is a screen shot of an example online user interface in accordance with one or more embodiments described herein.

### DETAILED DESCRIPTION OF THE FIGURES AND SOME EXAMPLE EMBODIMENTS

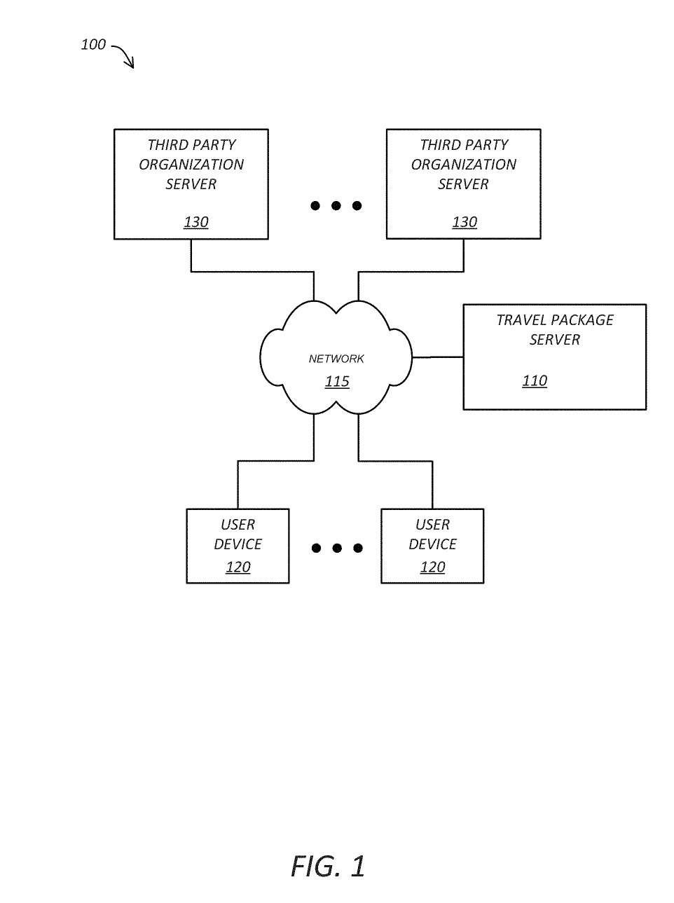

Referring now to FIG. 1, illustrated therein is an example system 100 consistent with one or more embodiments. The system 100 comprises a Travel Package Server 110, a plurality of User Devices 120 and a plurality of Third Party Product Servers 130. The system 100 is one example embodiment of a system which may be operable to facilitate at least some embodiments described herein. In other words, the system 100 may be useful in providing for a travel product service (e.g., which may operate the Travel Package Server 110) which provides various tools and resources to allow for obtaining information from a user who is a traveler or potential traveler (e.g., through a set of questions or options that are generated for the user based on input provided by the user, such as preliminary travel plan information, employer restrictions information, user preferences and/or answers to previous questions or options output to the user), the information being used to generate a plurality of customized travel packages that provides for at least one of (i) cost savings to the user; (ii) cost savings to a third party (e.g., an employer of the user); and (iii) monetary or other rewards to the user (e.g., each of the foregoing in varying degrees based on how far off from the traveler's preferred itinerary the travel package components are). As can be appreciated upon reading the present disclosure, the travel package service described herein may be particularly useful to business travelers and their employers.

In some embodiments, one or more of User Devices 120 and/or Third Party Servers 130 may be operable to communicate with Travel Package Server 110 via a network 115. The network 115 may comprise, for example, a mobile network such as a cellular, satellite or pager network, the Internet, a wide area network, another network or a combination of such networks. It should be understood that although not shown in FIG. 1, other networks and devices may be in communication with any of the devices of system 100 and/or that network 115 may comprise two or more networks operable to facilitate the routing of communications among the devices of system 100. For example, in one embodiment, both the Internet and a wireless cellular network may be involved in routing communications among two or more components of the system 100.

In some embodiments, additional devices that are not shown in FIG. 1 may be part of a system 100. For example, one or more servers operable to serve as wireless network gateways or routers may be part of system 100. In other embodiments, some of the functionality described herein as being performed by Travel Package Server 110 may instead or in addition be performed by a server of another entity operating on behalf of the Travel Package Server 110 (e.g., the travel package service which operates Travel Package Server 110 may outsource some functionality or otherwise allow some functionality to be performed by servers of other entities, such as registration of new users or new third party organizations, sharing of marketing content on social media sites, authorization of credit card transactions, etc.).

In some embodiments, the Travel Package Server may communicate with one or more servers of another entity that is not operated on behalf of the same entity that controls the Travel Package Server 110. In one example, if a user maintains a social media account and grants permission to the Travel Package Server to monitor information posted by the user to his social media account or post information to the social media account on behalf of the user, such content and/or social media account may be stored on a server of another entity and be accessible by Travel Package Server 110. In another example, travel product information (e.g., available seats on particular flights, availability of hotel rooms in particular hotels) may be stored on a server of another entity (e.g., one with which the entity operating Travel Package Server 110 has contracted in order to obtain information or access to certain products, availability, special rates or special terms) and the Travel Package Server 110 may be operable to access such information or request such information. Thus, a server of another entity may be a part of system 100 or otherwise be operable to communicate with Travel Package Server 110 (e.g., by allowing Travel Package Server 110 access to certain data or transmitting certain data to Travel Package Server 110, whether in response to a particular query or otherwise). It should be understood that any of the functionality described herein as being performed by the Travel Package Server 110 may in some embodiments be performed by such server of another entity.

The Travel Package Server 110 may comprise one or more computing devices, working in parallel or series if more than one, operable to facilitate the generation of a custom travel package or a custom offer for an a la carte product or service, for a user. The Travel Package Server 110 may be operated by or on behalf of an entity which offers services to facilitate such custom travel packages or a la carte product or service offerings, in accordance with embodiments described herein. As described herein, the Travel Package 110 may be operable, in accordance with some embodiments, to (i) communicate with a User Device 110 (e.g., receive login credentials from the User Device, receive parameter values or information defining a user's upcoming trip, receive answers to questions output to the user via a special interface designed to identify the boundaries of the user's flexibility allow the system to value such flexibility, etc.); (ii) generate, manage and/or update one or more custom travel packages, including financial or other incentives, for a user; and/or (iii) communicate with a Third Party Server 130 (e.g., to receive data or information from one or more Third Party Servers 130, such as availability of products/services, availability of incentives usable for providing savings or a monetary reward as part of a travel package and/or rate information useful for generating a custom travel package for a user). Information from a Third Party server may also comprise, for example, content such as trademarks or other proprietary information for use in outputting a customized online travel package interface to a user. The Travel Package Server 110 may further be operable to transmit data to one or more Third Party Servers 130, such as data indicating pending, output or accepted custom travel packages (or information about relevant components thereof) that have been offered to customers of the travel package service, payments due to a third party based on its products that have been included in an accepted travel package, booking requests based on components of a travel package that have been accepted by a customer, etc.

A User Device 120 may comprise a computing device associated with a user participating in a campaign for a third party organization or otherwise utilizing the services of the Travel Package Server 110. For example, a User Device 120 may comprise a personal computer such as a desktop, laptop or tablet computer, a cellular telephone or a smartphone or other mobile device. A User Device 120 may be operable, in accordance with some embodiments, communicate with the Travel Package Server 110 to (i) log in to the Travel Package Server 110 (e.g., to register, access, request or manage a customized travel package and/or redeem or manage monetary incentives such as gift cards earned by a user for accepting custom travel packages); (ii) receive information on travel packages accepted by the user from the Travel Package Server 110 (e.g., a custom travel package update or reminder, etc.); (iii) receive other information from the Travel Package Server 110 (e.g., rewards earned by the user, special offers for redeeming monetary rewards previously earned by the user, updates on friends or associates of the user who have joined the travel service, etc.). In some embodiments, the travel package server that operates the Travel Package Server 110 may offer a downloadable software application (“app”) that allows a user to efficiently interact with the Travel Package Server via a mobile or other user device.

A Third Party Server 130 may comprise one or more computing devices, working in parallel or series if more than one, operable to communicate information to or from the Travel Package Server 110. Such information may comprise, for example, (i) content such as trademarks, logos, images or videos of the third party to be used in presenting a custom travel package or flexibility options for in creating a custom travel package for a user; (ii) rules or terms of purchase applicable to a component of a travel package associated with the third party (e.g., rules of an airline, wherein a travel package includes a seat on a flight of that airline; rules of a hotel, wherein a travel package includes a room at the hotel, etc.), as to be output to a user to whom a travel package is output; (iii) special rates, terms or arrangements (or updates or limitations to such) as between the travel package service and the third party organization; (v) financial information (e.g., a financial account identifier for an account into which payments from the travel package service the third party (e.g., for travel packages booked by the travel package server) are to be deposited); and (vi) information or terms relevant to redeeming monetary incentives (e.g., by exchanging them for gift cards usable at product or service providers comprising a third party). For example, in accordance with some embodiments, a Third Party Server 130 may comprise a server of a product or service provider that has agreed to accept gift cards issued or provided by the travel package service to its customers who have earned such gift cards by accepting travel packages offered by the travel package service. In such embodiments the Travel Package Server 110 may communicate with a Third Party Server 130 regarding such gift cards (e.g., to identify unique identifiers and corresponding monetary amounts defining gift cards provided by the Travel Package Server that are redeemable at retail locations of the third party).

It should be noted that whenever information is described as being “transmitted” to a device of system 100 or other systems described herein, it is intended to encompass both a “push” embodiment in which the information is pro-actively pushed or output to the device by another device and a “pull” embodiment in which the device contacts another device in order to query for any updated information or changes in information.

In some embodiments, any of the components 110, 120 and 130 may communicate with one another directly or indirectly, via a wired or wireless medium such as the Internet, LAN, WAN or Ethernet, Token Ring, or via any appropriate communications means or combination of communications means. For example, in one embodiment communication among any and all of the devices of system 100 may occur over the Internet through a Web site maintained by computer on a remote server or over an on-line data network including commercial on-line service providers, bulletin board systems and the like. In some embodiments, communication among any of the components of system 100 may occur over radio signals, cellular networks, cable network, satellite links and the like.

The system 100 may be operable to facilitate communication using known communication protocols. Possible communication protocols that may be useful in the system 100 include, but are not limited to: Ethernet (or IEEE 802.3), ATP, BLUETOOTH, SMPP Protocol (e.g., SMPP Protocol Version 3.4), HTTP, HTTPS, and Transmission Control Protocol/Internet Protocol (TCP/IP). Communications may be encrypted to ensure privacy and prevent fraud in any of a variety of ways well known in the art, some of which are described herein.

It should be understood that any or all of the devices of system 100 may in some embodiments comprise one or more of (i) an input device; (ii) an output device; (iii) an input/output device; or (iv) a combination thereof.

An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale.

An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser.

An input/output device may comprise components capable of facilitating both input and output functions. In one example, a touch-sensitive display screen comprises an input/output device (e.g., the device outputs graphics and receives selections from an authorized person).

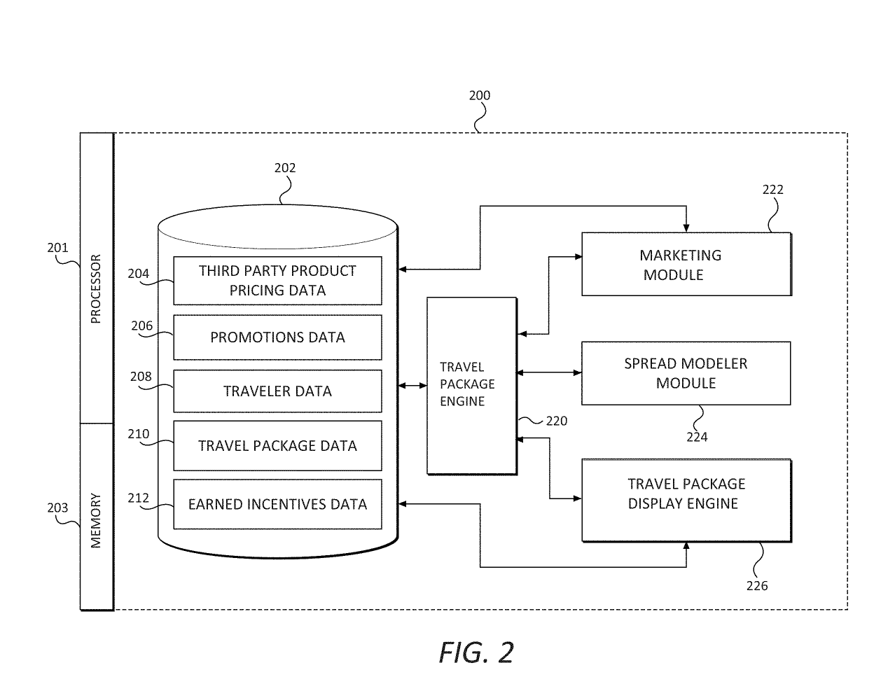

Referring now to FIG. 2, illustrated therein is illustrated therein is a computer system 200, which may be useful for implementing one or more embodiments described herein. For example, the computer system 200 may, according to some embodiments, be configured to generate, offer, manage and/or facilitate customized travel packages based on (i) flexibility boundaries of a traveler/user determined by the system responsive to data provided by the traveler/user (whether these be initial flexibility boundaries based on the user's initial input of a preferred itinerary or expanded flexibility boundaries based on the user's modifications defining an acceptable itinerary based on offered incentives or rewards); and (ii) terms, rates and availability of travel service components as provided by third parties such as airlines and hotels. The computer system 200 may further be operable to track, manage and/or facilitate the accumulation of monetary incentives earned by a user/traveler upon accepting one or more travel packages from the travel package service described herein and the redemption of such incentives (e.g., the redeeming of such incentives for gift cards or other rewards).

The system 200 may be implemented using one or more processors, such as processor 201, in conjunction with one or more tangible computer readable storage medium devices, such as memory device 203. The operations described herein may be divided across a plurality of computing systems, and are shown to reside in a single processing device of FIG. 2 so as to simplify the description. The computer system 200 may, for example, be operated by or on behalf of an entity which facilitates customized travel packages in furtherance of third party organizations by communicating with (i) one or more users and (ii) one or more third party organizations. In one embodiment, system 200 may comprise the Travel Package Server 110 of system 100 (FIG. 1).

In some embodiments, additional devices or components that are not shown in FIG. 2 may be part of a system for facilitating customized travel packages as described herein. For example, one or more servers operable to serve as wireless network gateways or routers may be part of such a system. In other embodiments, some of the functionality described herein as being performed by system 200 may alternatively or in addition be performed by a third party server operating on behalf of the system 200 (e.g., the entity operating the Travel Package Server 110 may outsource some functionality, such as registration of new users, booking of travel package components, collecting of payments or issuance of gift cards). Thus, a third party server may be a part of a system, such as that illustrated in FIG. 2. It should be understood that any of the functionality described herein as being performed by the system 200 may in some embodiments be performed by such a third party server. For example, one or more of the functions or processes described herein as being performed by system 200 or a component thereof (e.g., a module or software application of system 200) may be implemented with the use of one or more cloud-based servers which, in one embodiment, may be operated by or with the help of a third party distinct from the entity to which users and third party organizations provide information in order to create or manage customized travel packages. In other words, while in some embodiments the computerized system 200 may be implemented on servers that are maintained by or on behalf of a particular company or business which helps create such customized travel packages or customized offers for a la carte products/services, in other embodiments the system 200 may at least partially be implemented using other arrangements, such as in a cloud-computing environment, for example.

The computer system shown in the embodiment of FIG. 2 includes a database 202, which may store one or more of the following: (i) third party pricing data 204, which may include information defining travel products available from third parties (e.g., hotel room inventory from various hotels, flight information for flights available from various airlines), including rates, restrictions and terms of purchase as they would apply to such products if they were included in a custom travel package generated by the travel package service described herein; (ii) promotions data 206 (which may also be referred to as available incentives data), which may include information regarding any currently available promotions available from third parties that may be useful in determining values for one or more parameters of a custom travel package; (iii) traveler data 208, which may include information corresponding to one or more travelers or users of the system, such as preferences, history of offers accepted or rejected (e.g., travel package information regarding travel package offers accepted or rejected by the user), travel history, financial information (e.g., preferred credit card), a value or rating assigned to the traveler by the system, profile information (e.g., gender, employer, address, job title or category, associated family members, friends or associates, etc.) and/or a unique identifier or account login credentials for the traveler (of course in some embodiments different types of data corresponding to a traveler may be stored in different databases or tables); (iv) traveler package status data 210, which may include information specific to one or more custom travel packages generated, offered, accepted and/or utilized by a traveler/user of the system; and (v) earned incentives data 212, which may include information pertaining to the amount of monetary incentives earned by participating users of the system (e.g., a record for each traveler who has earned monetary or other incentives may be stored, with the corresponding value of incentives earned and/or value of earned or redeemed gift cards stored in each record). Of course the foregoing types of data are examples only and additional and/or different types of data may be stored (e.g., participating retailers that accept gift cards for which monetary incentives are redeemed, and the terms or special offers associated with such).

The database 202 may, for example, be implemented using any well-known database management systems, including Microsoft SQL, Oracle, IBM DB2, etc. It should be noted that in some embodiments, database 202 (or at least some of the data described as being stored therein) may be stored in memory 203 and/or in another memory device accessible to the memory 203 and/or to processor 201. For example, in one embodiment database 202 (or at least some of the data described as being stored therein) may be stored in a memory of a third party server, such as a server of a cloud-based computing service with which a company may contract for purposes of storing data or which may store data that is accessible to the travel package server.

The computer system shown in the embodiment of FIG. 2 includes, in accordance with some embodiments, one or more modules, programs, software engines or processor instructions for performing at least some of the functionalities described herein. In the example embodiment of FIG. 2, the system 200 may further comprise one or more software module(s) or engine(s) 220-226 for directing the processor 201 to perform certain functions. In accordance with some embodiments, software components, applications, routines or sub-routines, or sets of instructions for causing one or more processors to perform certain functions may be referred to as “modules” or “engines”. It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine or computing device without departing from the spirit and scope of the invention(s) described herein.

It should be understood that any of the software modules, engines or computer programs illustrated therein may be part of a single program or integrated into various programs for controlling processor 201. Further, any of the software modules, engines or computer programs illustrated therein may be stored in a compressed, uncompiled, and/or encrypted format and include instructions which, when performed by the processor 201, cause the processor 201 to operate in accordance with at least some of the methods described herein. Of course, additional and/or different software modules, engines or computer programs may be included and it should be understood that the examples illustrated and described with respect to FIG. 2 are not necessary in any embodiments. Use of the terms “module” or “engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for ease or convenience of description only and such functionality may in fact be a part of, or integrated into, another module, engine, program, application, or set of instructions for directing a processor of a computing device.

According to an embodiment, the instructions of any or all of the software modules, engines or programs described with respect to FIG. 2 may be read into a main memory from another computer-readable medium, such from a ROM to RAM. Execution of sequences of the instructions in the software module(s) or programs causes processor 201 to perform at least some of the process steps or functionalities described herein. In alternate embodiments, hard-wired circuitry may be used in place of, or in combination with, software instructions for implementation of the processes of the embodiments described herein. Thus, the embodiments described herein are not limited to any specific combination of hardware and software.

In the example embodiment illustrated in FIG. 2, a travel package engine 220 is illustrated as communicating with (i) the memory 202, (ii) a marketing module 222, (iii) a spread modeler module 224 and (iv) a travel package display engine 226. The modules and engines 220-226 are illustrated as being accessible to processor 201 to implement one or more embodiments described herein. As described, one or more of the modules or engines 220, 222, 224 and 226 may be operable to utilize at least some of the data stored in database 202. Further, in accordance with some embodiments, one or more of the modules or engines 220, 222, 224 and 226 may be operable to retrieve, manipulate, select, and/or otherwise determine data that is transmitted to and stored in database 202.

Travel Package Engine 220 may, in accordance with some embodiments, operate to manipulate the data from database 202 into appropriate records for processing by the marketing module 222, the spread modeler module 224 and/or by the travel package display engine 226 or to call on one or more of these modules or engines (e.g., the marketing module 222, the spread modeler module 224) for data useful in generating such packages in conjunction with data from database 202. For example, travel package engine 220 may be operable to create a custom travel package, including a value of incentives to offer to a particular traveler based on that traveler's itinerary and flexibility thereon, based on some of data stored in one or more records or entries of database 202 (e.g., based on data in the third party product pricing data 204, the promotions data 206 and/or the traveler data 208) and information from spread modeler module 224 and marketing module 222. The travel package engine may be operable to generate such a package, and transmit an indication of the custom travel package to be stored in another record or entry in the database 202 (e.g., in travel package data 210) and/or to transmit such data for use by the travel package display engine 226.

In some embodiments, one or more of the modules or engines of system 200 may further be operable to facilitate usage of (and, in some embodiments, gathering of) data posted by or provided by a user on social media (e.g., information posted by or provided by the user to sites such as FACEBOOK™, TWITTER™, TUMBLR™, LINKEDIN™ or GOOGLE+™). For example, as described herein, the system may be operable to calculate a value, category or rating for a particular traveler or user based on how many connections the user has on LINKEDIN or another social media site, the job title or company of the user as determined from LINKEDIN or another social media site, whether the user posts a recommendation of the travel package service on FACEBOOK or another social media site, etc.

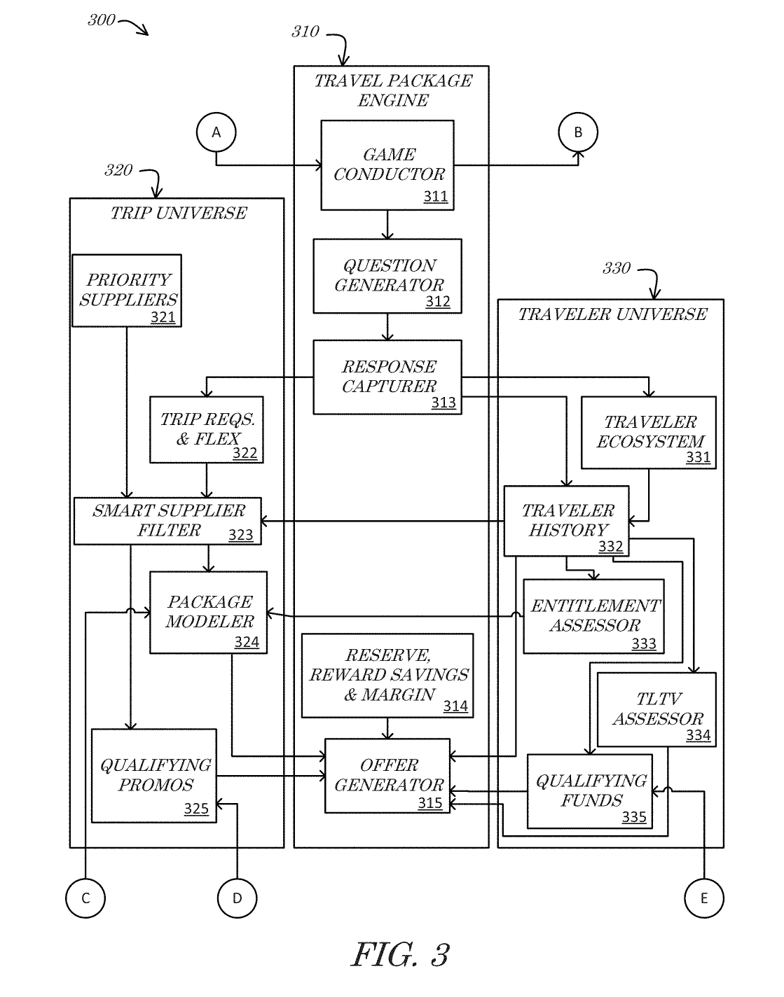

In accordance with some embodiments, a customer/traveler who initiates a transaction or booking with a travel package service as described herein may be presented with a plurality of questions (e.g., one question at a time, each question being considered a “turn” in some embodiments in which the process of capturing and maximizing the customer's trip flexibility and criteria is embodies as a sort of game in which the customer may earn rewards while answering questions). Some information obtained from the customer via these questions may be required information (e.g., origin and destination cities, travel dates, first three acceptable airline brands, etc.). In some embodiments, the questions seeking required information may not have any reward offers associated therewith. Other questions may be designed to identify or maximize a degree of flexibility a customer has with respect to certain criteria for the trip (e.g., class of seat, number of stops, time of departure, acceptable areas of destination city for a hotel, etc.). These types of questions may correspond to multiple answer choices and at least one of the answer choices may correspond to a reward offer (e.g., if you choose answer B, you get $20 in gift card rewards for this trip; if you choose answer C, you get $50 in gift card rewards for this trip). Such output of questions and processing of answers to help generate a custom travel package, including a value for a monetary incentive included therein or offered for various flexibility options during the question process, may be facilitated by the Travel Package Engine 220 and/or the Travel Package Display Engine 226 (e.g., working together with the database 202 and/or at least one of the modules 222 and 224). FIG. 3 illustrates one example conceptual architecture for a Travel Package Engine (e.g., Travel Package Engine 200) as it may be embodied within a specific example environment.

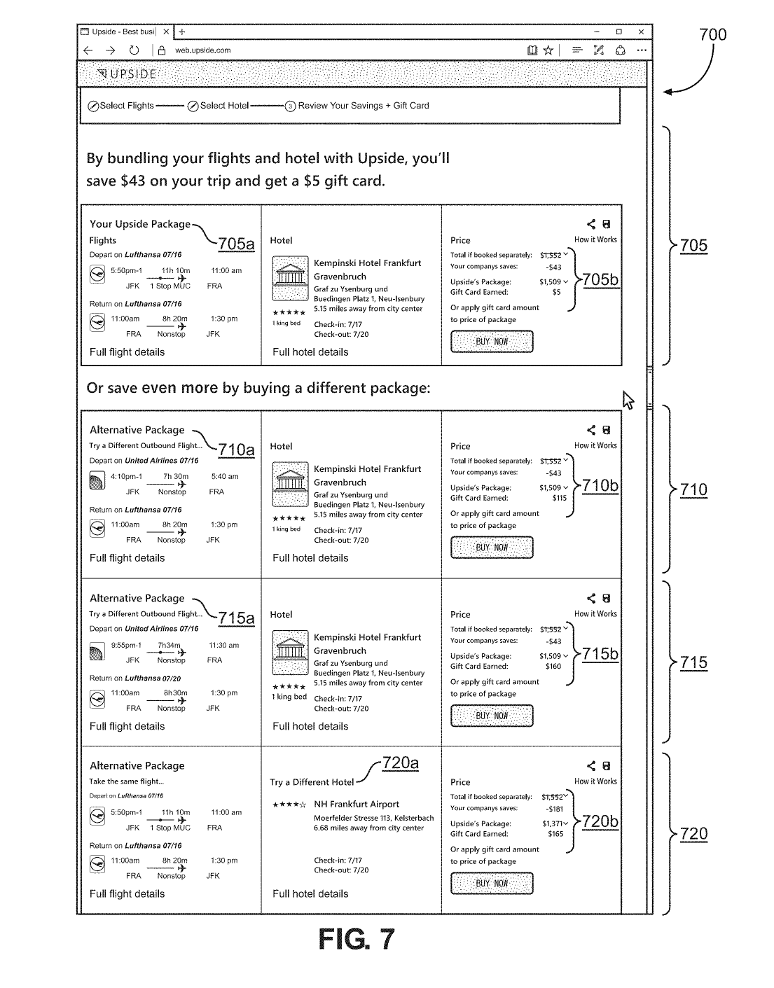

In accordance with some embodiments, rather than answering several questions one at a time (each of which may be associated with multiple choices of answers, each choice corresponding to a different incentive or reward amount), a user may be provided with an interface into which (s)he can input a preferred itinerary and the system can use this input to generate available package component choices for the user. Once the user makes selections from the available package components (e.g., preferred flight and preferred hotel from the available choices), the system can generate a customized travel package and output this customized travel package to the user, along with alternate travel packages that are similar but that have slightly different component values (e.g., a different flight or a different hotel). Each of the customized travel packages output to the user may correspond to respective values for discount (vs. the sum of retail prices for the components of the package) and monetary incentive (to be provided to the user in exchange for purchasing that particular package). FIG. 7 illustrates an example interface for such embodiments and FIG. 8 illustrates a process flowchart for such embodiments.

Referring now to FIG. 3, illustrated therein is an example conceptual architecture for a Travel Package Engine 310 (e.g., an embodiment of Travel Package Engine 200), one that interacts with different virtual environments or groupings of data, data sources and software functionality labeled for ease of reference as the “Trip Universe” and the “Traveler Universe.” The grouping of data, data sources and software functionality into a “Trip Universe” and a “Traveler Universe” is for convenience only and should not be interpreted in a limiting fashion. In some embodiments, at least one of the data, data sources and software functionality of at least one of the “Trip Universe” and a “Traveler Universe” may be considered a component of the Travel Package Engine 310. Similarly, at least some of the data or software functionality illustrated as being part of the Travel Package Engine 310 may, in other embodiments, be a component of another program, engine, data storage scheme or engine. In accordance with some embodiments, any or all of the data or software functionality illustrated as components of the Travel Package Engine 310, the Trip Universe 320 and/or the Traveler Universe 330 may comprise component(s) of the system 200 (FIG. 2).

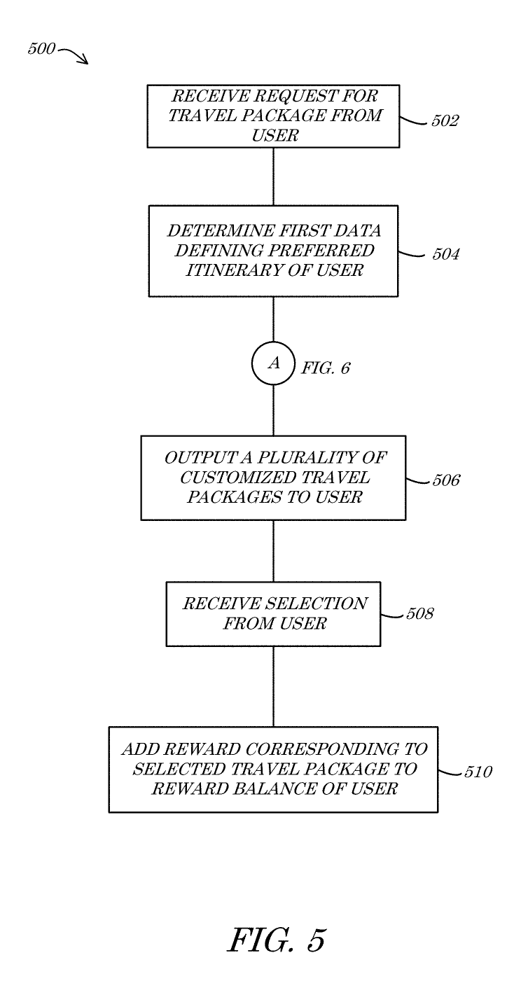

The various data, modules and engines described herein are merely examples of how a system architecture may be designed to implement at least some embodiments; various modifications may be made to the system architecture without departing from the spirit and scope of the invention(s). It should be understood that a function that is described herein as being carried out by a particular engine or module may, in other embodiments, be carried out by a different engine or module or distributed over a plurality of engines or modules. For example, in one embodiment the system may comprise (i) a first system module programmed to generate questions or data input fields and capture responses or input data from a user in order to identify first data defining a preferred travel itinerary of the user; (ii) a second system module programmed to access an electronic inventory of incentives available for generating customized travel packages, the electronic inventory defining second data; and (iii) a third system module programmed to generate a plurality of travel packages based on the first data and the second data to be offered to the user. A processor of a system may be operable with the first system module, the second system module and the third system module to: (a) receive, via an online website interface and from a first user, a request for a travel package; (b) determine, by use of the first system module and in response to the request, first data defining a first preferred travel itinerary of the first user and being of a first scope; (c) determine, by use of the second system module and based on the first data, which incentives in the electronic inventory of incentives are within the first scope; (d) generate, by use of the third system module and based on the first data determined in (a) and the incentives determined in (b), at least two travel packages to offer to the first user, each travel package being defined by a distinct value for each of: (i) a first variable defining a first component of the travel package; (ii) a second variable defining a second component of the travel package; (iii) a total price of the travel package; (iv) an amount of savings to be realized by purchasing the travel package as compared to a sum of retail prices for each variable of the travel package; and (v) a value of a reward to be provided to the user in exchange for purchasing the travel package; and (e) output, via an online interface, the at least two travel packages as alternative offers for the user. FIGS. 5, 6 and 7 provide additional example embodiments that may be implemented in a system that utilizes such components and performs the steps above.

None of the example data, modules or engines described herein are necessary and the functionalities of the various modules and engines described herein may be combined differently or carried out by different modules or engines than those described or using data different from that described.

In accordance with some embodiments, the Travel Package Engine 310 comprises (i) data, software and/or hardware functionality referred to as a game conductor 311; (ii) data, software and/or hardware functionality referred to as a question generator 312; (iii) data, software and/or hardware functionality referred to as response capturer 313; (iv) data, software and/or hardware functionality referred to as reserve, reward savings and margin 314; and (v) data, software and/or hardware functionality referred to as an offer generator 315. In accordance with some embodiments, the Trip Universe 320 comprises (i) data, software and/or hardware functionality referred to as priority suppliers 321; (ii) data, software and/or hardware functionality referred to as trip requirements & flexibility 322; (iii) data, software and/or hardware functionality referred to as smart supplier filter 323; (iv) data, software and/or hardware functionality referred to as a package modeler 324; (v) data, software and/or hardware functionality referred to as qualifying promotions 325. In accordance with some embodiments, the Traveler Universe 330 comprises: (i) data, software and/or hardware functionality referred to as traveler ecosystem 331; (ii) data, software and/or hardware functionality referred to as traveler history 332; (iii) entitlement assessor 333; (iv) TLTV assessor 334; and (v) qualifying funds 335. Some example uses and implementations of the data, software and/or hardware functionality illustrated in FIG. 3 will now be described in the context of various embodiments.

In accordance with some embodiments, a Travel Package Engine 310 may, upon a customer initiating a transaction and based on a variety of factors, identify at least one of: (i) a Target Reward (TR) for the transaction (i.e., a particular value in rewards that the system would like to get the customer to accept by the end of the questions, in an effort to make the customer very happy with the transaction and likely to come back and recommend the system to others); (ii) a Minimum Reward (i.e., the least value in rewards that the system would like to get the customer to get to by the end of the questions); (iii) a Maximum Reward (i.e., the most value in rewards that the system is willing to provide to the customer); and (iv) an allocation of the reward value amounts among the questions (and particular answer choices) throughout the questions that are not seeking required information. In some embodiments, the allocation of reward value amounts (or other data, such as Maximum Reward) may be dynamically adjusted throughout the question process as the customer proceeds through the questions and provides answers (e.g., a question placed later in the process may have its associated reward amount increased if a customer has not taken sufficient rewards in answering earlier questions to achieve the Minimum Reward or Reward Goal).

The system may be programmed to calculate any of (i)-(iv) in the preceding paragraph based on at least one of the following example factors (other factors may be utilized, the following factors are for illustrative purposes only and are not intended to be limiting): (a) information about the traveler (e.g., calculated lifetime value for the traveler, which may be based on where the traveler works, data determined from social media accounts of the traveler, whether this is the first time the traveler has used the Upside system, etc.); (b) information about the trip being booked (e.g., foreign vs. domestic travel, the popularity of the route, etc.); (c) information about the current inventory/preferred rates available to the system (e.g., if system can get the traveler on a particular flight for a very low price, this may cause the available max reward to be increased).

In some embodiments, the Travel Package Engine 310 may receive from another module in the system or determine based on data available to it one or more of the following: (i) at least one goal for a particular customer (e.g., refer 4 friends to system); (ii) at least one goal for a particular transaction (Airline A is priority 1 for package, Airline B is priority 2, etc.); (iii) rewards to offer throughout the booking process that are best for maintaining the lifetime value of the customer or best long-term experience for the customer, even if a reward/choice combination does not maximize the margin or cost savings for a current transaction; (iv) a value to attribute to a customer's flexibility on a particular parameter or choice (i.e., on a particular choice of a particular component of a package). In some embodiments, the Rewards Engine or another module in the system may be programmed to determine and balance or consider each of (i) a transaction value for a given customer; (ii) an inferred customer acquisition value for the customer; and (iii) a lifetime value for the customer.

In one embodiment, a customer booking a trip through the travel package system described herein will be asked to agree to some minimum flexibility (e.g., 3 acceptable airlines and 3 hotel brands) and then provided with a plurality of questions to further explore and push the boundaries of the customer's flexibility (e.g., to determine a preliminary scope of the customer's itinerary and then to expand that scope), with monetary incentives being offered in exchange for the customer agreeing to be more flexible on certain aspects of the trip or to expand the scope of his itinerary (e.g., how many stops, time of departure, acceptable locations for a hotel, etc.). Once the final parameters of the customer's requirements and range of flexibility (or scope of itinerary) are determined, the system dynamically generates at least one package (e.g., airline and hotel) that meets the customer's requirements and fits within the flexibility ranges (or scope of itinerary) agreed to by the customer. Once the customer accepts and books a package, the customer is provided with the monetary reward (e.g., based on which offers for maximizing flexibility the customer agreed to during the question process or based on what variables for the travel package components the system identifies as potentially acceptable to the customer based on the scope of his itinerary). In one embodiment, the monetary reward is in the form of gift cards or a value the customer can redeem for gift cards usable at one or more partner retailers. In one embodiment, a gift card reward value account is maintained for the customer and the reward value for accepting a particular travel package is added to the customer's account. At the customer's convenience, the customer may allocate particular amounts of the value to different available retailers and have gift cards issued in the selected values for the selected retailers. In one embodiment, the gift card value does not expire. In one embodiment, once a gift card is issued to a customer, it is not returnable or cancellable (even if the customer ends up cancelling the trip based on which the reward value used for the gift card was earned).

It should be noted that the customer, in many embodiments, is provided with a reward associated with an offer the customer accepted (e.g., $100 in reward if you agree to add a stop to at least 1 leg of the trip) even if the particular point of flexibility is not incorporated into the customer's final package (e.g., customer still gets the $100 even if the final package presented to the customer does not include any stops). The reward is in exchange for the flexibility or an expanded scope of an itinerary, for being willing to accept packages that fit within the boundaries defined by the accepted choice associated with the reward.

The Travel Package Engine 310 may comprise or access a plurality of modules or sub-routines which each have distinct functionalities, functions to obtain from a customer, for a particular transaction or trip booking, (i) the requirements for the customer's trip (e.g., origin and destination cities, dates for trip); and (ii) the boundaries of the customer's flexibility for various parameters of the trip or boundaries for a scope of the customer's itinerary (e.g., how many stops, areas of destination city in which hotel can be located, time of departure or return, whether another person is/can go on trip, which hotel brands and airline brands are acceptable, etc.). In obtaining from the customer the boundaries of the customer's flexibility or scope of the customer's itinerary, the software attempts to maximize the range of flexibility or scope by identifying and offering specific monetary rewards in exchange for the customer agreeing the extend his flexibility or scope for specified parameters. In some embodiments the system is operable to dynamically modify the available reward values for certain parameters based on the customer' responses to previously presented questions.

In one embodiment, the Game Conductor 311 and the offer generator 315 may function to manage the game flow and customer's experience for a particular transaction (e.g., what questions are asked, in what order, whether additional questions are necessary or should be omitted based on previously provided answers and/or accumulated reward).

In some embodiments, the customer's experience in participating in a transaction/booking with the travel package system may be categorized into three distinct phases: (i) pre-offer phase; (ii) offer phase; and (iii) post-offer phase. Example implementations of these phases are summarized below:

(i) Pre-Offer Phase:

In one embodiment, in a pre-offer phase of a transaction, the following tasks may be undertaken:
determine the customer's reward profile (based on which the TR, particular questions, etc. may be determined);
determine the trip requirements and calculate the expected spread, which is the difference between the retail cost of the trip the customer is entitled to take (e.g., cost of cheapest (or average or median) air & hotel found on 3^{rd} party retail sites, that the customer is entitled to based on trip requirements, default values, company's travel policies or customer's typical or preferred travel choices, etc.) less the cost of the trip the customer chooses from the travel package service (total travel package cost for air & hotel based on the particular air and hotel choices indicated by the traveler as his preferred choices or as defining his initial scope of itinerary):

SPREAD_{TRIP}=COST_{ENTITLED}_{_}_{TRIP}−COST_{CHOSEN}_{_}_{TRIP}
Since the customer's choices are not fully known until the end of the booking process, the above calculation may be performed, for example, using estimates or assumptions for certain variables (based on programmed logic). For example, an assumed discount multiple may be applied to the “entitled” strip costs (e.g., 20% for hotel and 5% for air) for an initial SPREAD calculation. As the traveler makes choices in answering questions presented during the booking process, more specific costs may be looked up and used to replace any initial estimates. Thus, the SPREAD may be updated dynamically throughout the booking process (e.g., particular preferred system rates, as offered to the travel package system by airline and hotel partners, for specific preferred choices indicated by the player may be used to calculate the SPREAD).
The “Pre-Offer Phase” may also comprise identifying the questions to be output to the customer during the remaining part of the booking process (e.g., questions to be asked during the “Offer Phase”, the rewards to be offered and the allocation of the rewards among the questions).
In some embodiments, the questions output to the player during the Pre-Offer Phase (e.g., to identify the trip requirements) may not include any reward offers; however, in some embodiments a small reward may be offered for one of the choices, in an effort to motivate the customer to continue with the booking process and answer further questions;

(ii) Offer Phase:

In this phase, the system attempts to broaden the range of the customer's flexibility within certain parameters of the trip or to expand the scope of the customer's itinerary (e.g., get the customer to add at least one stop to at least one leg of the trip, add acceptable times of travel, add acceptable airlines or hotels, increase the acceptable area of the destination city in which a hotel may be located, etc.) by outputting offers to the player in the form of questions, where different available answer choices may correspond to different reward values. In other embodiments, such as ones described with respect to FIGS. 5, 6 and 7, the system may attempt to broaden the scope of the customer's itinerary by providing to the customer offers for alternate travel packages that include alternate variables for one or more components of the travel package (different from what the customer selected as his preferred choice, such as an alternate flight or alternate hotel);
the system may try to steer the customer towards choices that will result in the highest cost savings by offering the largest reward values for those choices (e.g., if system has very favorable rate for a certain flight or hotel, it may offer a relatively high reward value in exchange for the customer agreeing to trip parameters that may be satisfied with inventory having these favorable rates);
in creating the offers to be output to the customer during the remainder of the booking process, the system determines a reward (e.g., Target Reward, Minimum Reward and/or Maximum Reward) by taking into account sources such as the following: (i) the SPREAD, (ii) any qualifying funds (also referred to as incentives herein, since qualifying funds are considered a type of incentive) available from the Qualifying Funds Module (described below) and (iii) any qualifying promotions available from the Qualifying Promotions Module 325 (described below; also referred to as incentives elsewhere herein since qualifying promotions are considered another type of incentive herein). As described herein, in some embodiments the benefit(s) of booking a trip through the travel package system may be shared among the customer/traveler and the employer (if different), with some allocated to the margin for the system. Thus, the system may utilize four conceptual “buckets” to represent the benefits from a transaction as designated among the various stakeholders:

SPREAD+Qualifying Funds+Qualifying Promotions=TOTAL BENEFIT for booking, may be allocated as illustrated in Table 1 below:

TABLE 1

| % Allocated to Reward | % Allocated to Savings | % Allocated to | Accumulated |
|---|---|---|---|
| (R_{ALL}) | (S_{ALL}) | Margin (M_{ALL}) | Reserve (X_{ACC}) |
| R_{ACC} = The accumulated | S_{ACC} = the accumulation of | M_{ACC} is the | Accumulation of |
| reward designated for the | monetary value designated for | accumulation of | monetary value that |
| traveler, which traveler can | the employer, allocated at a | monetary value | is undesignated. Can |
| earn by accepting offers for a | percentage for the employer | designated for Upside; | be designated for |
| particular booking, allocated at | (S_{ALL}) | allocated at a | other buckets during |
| a percentage for the traveler | | percentage for Upside | question output or |
| (R_{ALL}) | | (M_{ACC}) | even after booking. |
| May have a corresponding | May have a corresponding | May have a | Some value from |
| Desired Reward Threshold | Desired Savings Threshold | corresponding Desired | R_{ACC} or S_{ACC} may be |
| (R_{THRESH}) - monetary value | (S_{THRESH}) - monetary value | Margin Threshold | moved to X_{ACC} if the |
| system would like R_{ACC} to meet | system would like S_{ACC} to | (M_{THRESH}) - monetary | minimum reward |
| or exceed by the point of | meet or exceed by the point of | value system would | threshold or some |
| booking | booking | like M_{ACC} to meet or | other predetermined |
| | | exceed by the point of | condition has been |
| | | booking | satisfied. |
| At the conclusion of the Pre- | At the conclusion of the Pre- | At the conclusion of | |
| Offer Phase, a Trip Reward | Offer Phase, a Expected Trip | the Pre-Offer Phase, a | |
| may be calculated as follows: | Savings may be calculated as | Trip Margin may be | |
| TRIP_REWARD = | follows: | calculated as follows: | |
| SPREAD_{TRIP} * R_{ALL} | TRIP_SAVINGS = | TRIP_MARGIN = | |
| | SPREAD_{TRIP} * S_{ALL} | SPREAD_{TRIP} * M_{ALL} | |
| Examples*: For new or VIP | Examples*: For new or VIP | Examples*: For new | |
| Traveler, R_{ALL} may be 0.75 | Traveler and Regular Traveler, | or VIP Traveler, M_{ALL} | |
| while for Regular Traveler, | S_{ALL} may be 0.20 | may be 0.05 while for | |
| R_{ALL} may be 0.55 | | Regular Traveler, | |
| | | M_{ALL} may be 0.25 | |

*the numbers in these examples are provided for illustrative purposes only; any percentage allocation may be used; in some embodiments the traveler may provide input or select the allocation as between Reward and Savings; allocations may be adjusted dynamically during booking based on customer's choices

The system may, in some embodiments, be programmed to guide a traveler to make decisions/choices when answering questions or reviewing offers that will have the most impact on their reward. The system may, in some embodiments, allocate a portion of RAcc among the choices/offers to be output to the customer via a plurality of questions based on a variety of considerations and calculations, such as:
   A calculation of the SPREAD for each choice (the cost difference, for a given choice (e.g., class of seat for an outbound flight)) between what the customer could get if booking via a 3^{rd} party vs. booking through the customized travel package system described herein (also referred to as the UPSIDE™ system or UPSIDE™) may be made.
   The relative sensitivity of a given choice as compared to other choices that will be output to the customer (which may cause a Weight to be calculated and assigned to a given choice);
   Data defining a customer's profile or Lifetime Value of the Customer;
   Data defining a general customer profile or previous choices selected by similar customers;
   Where in the booking process a particular choice or question appears (e.g., the first few rewardable questions may correspond to relatively higher reward amounts, in order to capture the customer's interest);
   A desired game pace or pace in offering rewards throughout the booking process (see discussion of “epochs” herein)
The system may, in some embodiments, be programmed to function in a feedback loop throughout the booking process, such that customer selection of choices/offers when answering questions may impact reward allocation among subsequent questions. For example, if the customer has said no to so many offers up to now that it will be difficult to meet the Minimum Reward or RTHRESH by the end of the questions if the reward values for remaining offers stay the same, the system may increase certain reward values for upcoming questions, or even add or modify questions to steer the customer towards certain choices or reward amounts). Similarly, if the customer has accepted so many offers thus far that he is close to the Maximum Reward for the current booking, the reward values in upcoming questions may be decreased (or some questions may be removed or modified). Thus, in at least some embodiments, the system may dynamically allocate and re-allocate the RAcc among the choices being presented to the customer as a customer provides selections to choices (e.g., that are captured in the Response Capturer 313). In accordance with some embodiments, the system may be operable to include in its feedback look real time or near real-time feedback from other customers (e.g., customers answering questions and requesting travel packages or customers who previously accepted travel packages). In accordance with some embodiments, the system may be programmed to optimize its algorithms, scoring or selection of travel package components based on data collected from its customers, whether customers currently providing feedback or from stored customer data.

(iii) Post-Offer Phase—

In this phase, the system may be programmed to add an unexpected reward to the customer's package (e.g., as funded from the XACC or from any remaining amount of the RACC once the customer has finished making choices and reviewing offers). Such an unexpected reward (which may not be dependent on the customer making a particular choice or broadening their flexibility on any part of their trip) may be added to the RACC (i) randomly; (ii) for certain qualifying bookings (e.g., if the Minimum Reward has not been satisfied by a certain point in the questions, particularly for new customers); and/or (iii) for certain qualifying customers (e.g., a new customer or a customer who has not booked through the system for more than some predetermined period of time or a customer referred by another customer).

In accordance with some embodiments, a “bleed” variable may be added to the offer equation, to pad the reserve more when the minimum reward threshold for a traveler has been passed. For example, a “BLEED_OFF” variable may be applied after the threshold for the reward has been reached and may be modeled in the following pseudo-code:

BLEED_PCT = 0; //Variable Initialization
If (R_{ACC} ≥ R_{THRESH} && S_{ACC} ≥ S_{THRESH})

{BLEED_RATE = 0.02/100; // 0.02% Per $100
BLEED_PCT = BLEED_RATE * TRIP_SPREAD + 1;
X_{ACC} += (1 − BLEED_PCT) * R_{ALL} * SPREAD_TRIP;}

The bleed percentage (BLEED_PCT) may then be included in an offer calculation equation for a particular question or choice.

In accordance with some embodiments, the question generator 312 may function to generate the specific questions that will be output to a customer (and, in some embodiments, the particular order of the questions); may select the content for particular questions based on data provided by the customer and captured by the response capturer 313 (e.g. the particular airlines or hotel or city areas to include in certain questions, based on the required parameters of the customer's trip), customer profile, profiles of a generic customer, available inventory, qualifying promotions, etc.;
some questions may only pertain to a certain type of customer (e.g., new or VIP customers may be presented with certain questions that others are not) or transaction;
   questions initially determined for output during a particular transaction may be omitted during the flow of a transaction (e.g., remaining value in rewards available are insignificant compared to reward offers accepted by customers and outputting them may be unnecessary or detrimental to conversion rate (having customer accept a package)).

In accordance with some embodiments, the response capturer 313 may function to capture the responses provided by the customer to the questions output during the process of identifying the requirement criteria and flexibility of the customer for a particular trip; these responses may be temporarily stored and shared with other modules and some responses may be more permanently stored for future reference or use (e.g., building a customer profile, building a profile of customers who travel a particular route, etc.).

In accordance with some embodiments, the offer generator 315 may perform one or more of the following functions:

1. May function to receive input from Traveler Universe 330 (e.g., Traveler History Module 332, TLTV Assessor Module 334 and/or Qualifying Funds Module 335) and/or the Trip Universe 320 (e.g., Package Modeler Module 324 and/or the Qualifying Promos Module 325) to generate rewards to offer during game;

2. May function to determine the Target Reward (TR) for a transaction;
in some embodiments may also determine a Minimum Reward and/or a Maximum Reward;
in some embodiments the TR may be based on Total Lifetime Value (TLV) of customer looking at lifetime value of customer; the system may be willing to lose $ on a given transaction if value of customer is high enough (e.g., sign in with linked in profile, look at social media contacts), for same itinerary, 1 customer may be offered $100 to add a stop to itinerary while another customer may be offered $200 to add the same stop to the same itinerary if his lifetime value is higher

3. May include reward dispensing/allocation logic (determines how to dispense reward over course of game/turns/questions), as described above in Section II.A, and particularly in II.A.(ii);
(a) in one embodiment: there are 3 epochs of questions: start, middle, finish; dispense proportionally more reward in the beginning questions (steepest slope of reward) and near the end (less steep but still ascending slope) and less so in the middle (relatively flat slope); epochs defined by pre-defined question numbers and pre-defined percentage of TR
(b) in one embodiment: reward dispenser is a feedback mechanism in which answers to questions from customer cause changes to rewards for subsequent questions;
(c) in one embodiment: reward dispenser dispenses equally over each question in each (e.g., first) epoch. For example, reward per question in first epoch may be percentage (e.g., 0.4) of TR

Turning now to the Trip Universe 320, included therein is a priority suppliers module 321, that may function to store data indicating the hotels and airlines who have agreed to provide inventory to the travel package service at favorable rates, the relevant terms defining the inventory (e.g., geographical area, route, O/D, times, prices, classes of seats, types of rooms, etc.). The trip requirements and flexibility module 322 may, based on a customer's responses or input when first initiating a transaction (e.g., O/D cities, preferred times of travel, # of acceptable stops, preferred areas for hotel, preferred and/or acceptable airlines, hotels, seat classes and hotel stars, etc. as captured by the response capturer module 313 of the Travel Package Engine 310), this module may function to generate values for certain parameters for a customer's trip, including any “most have” criteria and the extent to which the customer is willing to be flexible on certain parameters.

In accordance with one embodiment, the smart supplier filter module 323 may function to receive data from (i) priority suppliers module 321; (ii) trip requirements and flexibility module 322; (iii) traveler history module 332 (Traveler Universe 330) in order to identify available and preferred value parameters (e.g., hotel(s), airline(s), flight(s)) that satisfy the customer's trip criteria within the customer's flexibility ranges for the various parameters. For example, based on the customer's responses as to which hotel(s) they are willing to stay in and which areas of their destination city they are willing to stay in (as well as, in some embodiments, data indicating which hotels the customer has stayed in in the past), the smart supplier filter module 323 may determine what airline or hotel it will try to get customer into for a particular transaction as well as other hotels, airlines and flights may be acceptable to the customer (e.g., system may determine first & second choices for airline, flight and hotel or a primary travel package and alternate travel packages to offer to the customer).

In accordance with one embodiment, the package modeler 324 may function to dynamically generate a package (or, in some embodiments, a plurality of packages, one of which may be designated as a primary package that most closely matches the customer's preferred itinerary and at least one alternate package that may be targeted to broaden the customer's scope of itinerary) for a particular booking based on data from at least one of (i) smart supplier filter module 323; (ii) pricing data from System Analytics and Published Price APIs (labeled as “A” in FIG. 3); and (iii) entitlement assessor module 333 (Traveler Universe 330). In one embodiment, the package modeler 324 may provide data defining possible package criteria (or possible values for parameters defining one or more packages) to offer generator module 315.

In accordance with one embodiment, the qualifying promotions module 325 may function to receive data from at least one of (i) smart supplier filter module 323; and (ii) a promotions catalog (labeled as “D” in FIG. 3, which may store inventory of available promotions from partner suppliers, which can be used to add to reward value for a booking and select which particular airline or hotel the customer should be steered to for maximum savings/reward). The qualifying promotions module 325 may, in one embodiment, provide data to the offer generator module 315 (Travel Package Engine 310), which data may be used as described above. In some embodiments, the promotions catalog may comprise a table in a database. In some embodiments, the promotions catalog may promotions or funds available from third parties that are usable towards a trip benefit for a customized travel package. In some embodiments, a particular promotion in a promotion catalog may be associated with one or more criteria that must be satisfied in order for the promotion to be usable towards a particular travel package. For example, a restaurant in a hotel may make a promotion available (e.g., up to $20 subsidy towards a travel package) but only for travel packages that include the particular hotel and/or only for customers who meet a certain profile (e.g., male customers between the age of 21 and 40 or who are otherwise deemed by the restaurant to be particularly desirable as customers for the restaurant).

Turning now to the Travel Universe 330, included therein is a traveler ecosystem module 331 and a traveler history module 332, one or both of which may function to store data on a traveler/customer based on past bookings, preferences, choices selected, offers accepted/rejected, etc. This data may be used for functions such as generating offers for subsequent booking and making selections for subsequent bookings (e.g., set estimated values when calculating Trip Spread).

The TLTV assessor module 334 may function to calculate the Total Lifetime Value (TLTV) for a customer. TLTV may, in accordance with some embodiments, be an estimate of value the customer is expected to provide to the system, not just from his/her own bookings but from bookings of others this customer may bring into the system. Factors that may be taken into account when calculating TLTV include, without limitation: (i) type/size of company the customer works for (e.g., large company means higher likelihood that customer will recommend system to more colleagues); (ii) position of customer within the company; (iii) type of job held by the customer, since certain jobs may incur more travel than others (e.g., salesperson vs. doctor); (iv) social media account data for customer (e.g., customer may be asked to sign in through his LinkedIn account, which may then be evaluated to help determine whether the customer has a large number of associations in the profile). The TLTV may be utilized to determine the magnitude of the Trip Reward (e.g., RAcc, as described above), an allocation of rewards among questions and/or the content of questions (e.g., a high TLTV customer may be asked fewer questions with relatively higher reward per question, to make the booking process as appealing as possible; a TLTV customer may be offered higher rewards for referring others to the system, etc.). In some embodiments, a statistical model similar to that used in insurance underwriting may be used to calculate the TLTV of a customer.

In determining at lifetime value of customer, the system may in some embodiments be programmed to lose money on a given transaction if a value, rating or category of a customer is high enough (e.g., sign in with linked in profile, look at social media contacts).

In accordance with some embodiments, the TLTV may be determined at the beginning of a booking process and used to calculate the total Reward or Reward Goal to be used for a current booking, as well as for allocating reward values to specific choices being offered to a customer. Thus, for same itinerary, 1 customer may be offered $100 to add a stop to itinerary while another customer may be offered $200 to add the same stop to the same itinerary if his lifetime value is higher.

In accordance with some embodiments, the entitlement assessor module may function to calculate or estimate a Cost for a trip a customer “entitled” to take or that is the customer's most preferred itinerary (e.g., the customer's first choice for hotel and flight). Such a calculation or estimation may be based on, for example, responses the customer provides during the initial questions (e.g., 0/D cities, dates, travel policies of the customer's employer, etc.) that define the trip requirements for a transaction or the initial scope of a customer's itinerary. For example, based on the 0/D cities and dates of travel, at least one retail site via which the customer could purchase a travel package that meets this criteria may be accessed. In some embodiments this may be calculated based on the lowest cost retail outbound air, retail hotel, return air. In some embodiments this cost calculation may also take into account what the customer has indicates he is entitled to in terms of class of airline seat, star-rating of hotel, type of room, etc. An example of a Cost calculation for an “entitled trip” is provided below:

COST_{ENTITLED}_{_}_{TRIP}=COST_{CHEAPEST}_{_}_{RETAIL}_{_}_{OUTB}_{_}_{AIR}+COST_{CHEAPEST}_{_}_{RETAIL}_{_}_{HOTEL}+COST_{CHEAPEST+RETAOL}_{_}_{RET}_{_}_{AIR}

In some embodiments, default values and logic for calculating the above may be utilized. For example:
for the “AIR” variables, the “Big Three” airline brands (e.g., American, Delta and United) may be utilized. If all three do not service a leg of the trip, brands may be expanded to traveler's desired carriers. If all else fails, the lowest cost carrier may be found irrespective of Big Three or traveler preferences
a “0” may be used for # of stops on each leg;
airports may be selected that are closest to city center or based on other default criteria or 3^{rd} party website information;
for “Hotel” variable, traveler may be allowed to pick 3 brands or by default the “Big Three” hotel brands (e.g., Marriott, Hilton and Hyatt) may be selected. If all 3 are not available in the zone or city desired then cheapest 3 star hotel may be selected;

If customer is a returning customer, hotels or hotel zones may be selected based on stored data (e.g., as stored in the traveler history module 332).

The qualifying funds module 335 may store an indication of marketing or other funds that the system has available for use in calculating a Trip Reward (e.g., an RAcc, as described above). For example, the system may have a marketing budget which is replenished and made available via this module. In some embodiments, certain amounts of the budget may be only available for use in certain types of bookings or for certain types of customers (e.g., VIP or new customers, non-domestic travel, etc.).

In some embodiments, the system will require that a customer booking a trip initially agree to at least some minimum flexibility criteria (e.g., 3 acceptable airlines and/or 3 acceptable hotel brands). The system may then select the particular airline and hotel to include in the customer's package or a preferred travel package to offer to the customer (as opposed to alternate travel packages which may also be offered to the customer, as described with respect to FIGS. 5, 6 and 7. While the system may not immediately book the customer's seat and/or room once the customer purchases the package, at some point as the trip gets closer the system will book a seat with the airline defined in the package and/or a room with the hotel defined in the package. In some situations, a customer may cancel a trip after the airline seat and/or hotel room are already booked. Thus, the system will need to cancel the bookings and, if possible, refund the customer's payment. Depending on the timing, the type of booking (e.g., refundable vs. non-refundable ticket) and the refund policies of the airline or hotel, the system may not be able to fully refund the customer's payment. For example, the hotel room may be cancelled and refunded but the airline seat may no longer be refundable. In some cases, the customer may end up with a credit for a particular airline or hotel. Having a credit with a particular airline or hotel may be problematic in embodiments in which a customer, as a primary pre-requisite to booking with Upside, is required to agree to a plurality of airlines and/or plurality of hotel brands as acceptable for creating a package. Thus, having an open credit with a particular airline or hotel may be incompatible with the regular booking process of the travel package service. Such an open credit scenario may be handled in a variety of different manners. For example:

(a) customers that have an open credit with a particular airline or hotel may be routed to an alternate booking process path;

(b) to maintain the opaqueness of the package creation process, the customer may be informed that he will be re-booked on the airline with which he has a credit (or with the hotel) during one of the customer's next three (or some other number) of bookings, such that the customer is not certain which airline he will be booked on in a given booking.

As described herein, users of the package travel system may, in accordance with some embodiments, earn monetary rewards or incentives by accepting certain conditions or flexibility levels when defining their trip criteria (e.g., by accepting offers to expand flexibility on various aspects of trip bookings in exchange for monetary incentive) are added to an accruing Reward Account for a customer. In accordance with some embodiments, a cumulative monetary reward value earned by accepting offers for a particular travel package may be added to the Reward Account once the customer books (pays for) the package. The value in the Reward Account, in some embodiments, never expires. In some embodiments, at the customer's discretion, the customer may choose to redeem all or part of the value in his Reward Account in the form of gift cards. Gift cards may be available to a variety of online retailers (some may require that gift cards be purchased in minimum or predetermined denominations). Gift cards may in some embodiments, for majority of transactions, be issued electronically only (physical gift cards may be issued and mailed in certain circumstances). In accordance with some embodiments, once a gift card is issued, it will not be returnable or cancellable (even if a customer cancels a trip and receives a refund for a package that resulted in the reward value which was used to issue the gift card). Thus, in one example embodiment, if a customer cancels a trip and receives a refund for a package, the customer's Reward Account may be decremented by the amount of Reward that was originally part of the package. This may in some circumstances result in the Reward Account becoming negative, in which case subsequent rewards earned by the customer in future bookings may be used to offset the negative value in the account. In some embodiments, a credit card associated with the customer may be charged for a negative reward value in a Reward Account if the customer does not earn sufficient rewards in future bookings to bring the balance back above zero within some predetermined period of time (e.g., 90 days).

Applicant recognizes that at some points in time, different retailers may have different promotions available that can increase the value of a gift card when the customer is redeeming value in his Reward Account (e.g., Home Depot may have a special one month that for every $50 in value from your Reward Account that you add to a Home Depot gift card, you will get a $60 gift card).

In some embodiments, a traveler may be offered a monetary incentive for referring new travelers to the system. For example, Traveler A refers Traveler B and Traveler A receives 10% for all trip rewards earned by Traveler B for the next 12 months or for the first 10 transactions booked by Traveler B through Upside (numbers are examples only). Alternatively, Traveler A may be provided with a set amount of gift cards (e.g., $40 in gift card value) each time Traveler B books a trip with Upside (e.g., for the next 12 months or first 10 bookings).

In one embodiment, the system may utilize data in a traveler's social media accounts (e.g., who the traveler's “Friends” are on FACEBOOK or who the traveler's connections are on LINKEDIN) in order to track or facilitate referrals attributable to the traveler. In one embodiment, the traveler may be offered a monetary incentive in exchange for providing the system access and/or use to data in such social media accounts.

In one embodiment, a company may be allowed to register with the system and register all its employees and be the beneficiary (e.g., in the form of savings or in the form of monetary rewards such as gift cards) for all referral rewards for its employees (e.g., company gets 10% of all trip rewards earned by its employees for some predetermined period of time or for some predetermined number of bookings per employee).

In some embodiments, travel agents may have their own unique path through the system and/or be provided with data regarding a particular traveler or trip that is not output to the traveler. For example, a travel agent booking a trip for a traveler may have access to the goals for a particular package (e.g., the particular airline and/or hotel the system would like to steer the traveler to). Travelers may earn rewards or commissions for booking through the travel package service described herein.

In one embodiment a customer may be allowed to “lock in” a package price defined by certain parameter values but may not be required to select a particular flight until X days prior to departure. Or a customer can “lock in” in a price for a booked package such that the customer may be guaranteed to book the same package (or similar, as defined in the rules of the package) for the same price (e.g., within the next 12 months).

In one embodiment, a traveler who takes a specific trip repeatedly (e.g., a business traveler who repeatedly visits a client or vendor at a particular location on a regular basis) may be allowed to create a “template” for the trip, with the traveler's flexibility boundaries stored as part of the template, such that the customer need not go through all of the same questions each time the customer books the trip but may merely request “another one like this” when booking the next instance of a trip that is similar to a previously booked trip. In such embodiments, the system may offer the traveler a different travel package each time the traveler books the trip (e.g., based on different promotions available at any given time) but may re-use the answers the traveler previously provided to determine the boundaries of the traveler's flexibility for the trip when generating the travel package offer.

In one embodiment, the system may allow a customer to indicate a desirable option for a particular travel package or part of a travel package (e.g., the airfare component of a flight package). For example, an interface via which available travel package offers are output to a customer may include a “more like this” or similar button or indication that allows a customer to indicate to the system a particular travel package or component of a travel package that the customer likes, thus causing the system to configure or prepare yet another travel package that is similar to the travel package the customer indicated an affinity for or that includes the same component (or a similar component) as the one the customer indicated an affinity for.

Described above are some embodiments in which an offer for a particular customer may be generated or built by employing a “filter” mechanism in which certain options (e.g., airlines, hotel brands, flight times, etc.) are filtered out and not included in any travel packages offered to a player. In other embodiments, individual or particular options or values for different components (e.g., particular airlines or flight times for an airfare component and particular hotel brands or hotel locations for an accommodation component) are scored. The scores for individual components may be based on, for example, answers to questions provided by the customer, selections of values made by the customer in an interface aimed at obtaining from the customer an idea of the customer's preferred itinerary or preliminary scope of an itinerary, past offers or packages accepted by the customer, feedback from other customers, current incentives or rewards available from various vendors, etc. For example, in one embodiment each individual option for a given component may be assigned a number on a scale from −1 (for an option that the system determines to be the opposite of what the customer prefers or has selected as an acceptable value for a given component) to +1 (for an option that the system determines to be an exact fit for what the customer prefers or that matches exactly what the customer has selected as an acceptable value for a given component). In some embodiments, weights on individual components and/or options for a given component may also be utilized in a scoring algorithm. In one embodiment, a score is determined and continuously updated as a customer provides answers to questions or provides selections or input while requesting a package. In another embodiment, a preliminary score is determined and then the package options for that customer is rescored as additional data is received or retrieved by the system from memory. In some embodiments, different algorithms or factors may be taken into consideration for different types of components (e.g., airfare vs. hotel). In accordance with some embodiments, scoring for individual components and/or options within a specific type of component may also be utilized to identify or select incentive amounts for a package.

In accordance with some embodiments, a “shadow itinerary” may be identified or generated for a customer, in addition to the one or more travel package offers that are output to the customer. Such a shadow itinerary may be utilized, for example, to determine a “retail price” for a comparable package (that is, what the customer would have paid for a comparable trip with comparable or the same options if he/she had not utilized the system described herein). In one embodiment, the system may access or identify the top 10 retail rates for each option of each component and take the median of these to determine the package price (of course any number other than 10 may be utilized). In some embodiments, the shadow itinerary may be determined for the best fit itinerary the system determines the customer would have chosen based on the answers the customer provided and the available retail options. In accordance with some embodiments, the system may also calculate a spread between the retail price of the shadow itinerary and one or more travel packages output or offered to the customer. In some embodiments, this spread may be output to the customer and/or an employer of the customer.

As described herein, in accordance with some embodiments the system is operable to score or value one more of a customer's willingness to purchase, a customer's preference and a customer's non-preference for particular available options. In accordance with some embodiments, the system is able to quantify a customer's willingness to be flexible and incentivize an increase in such willingness or flexibility, thus steering the customer to something at least a bit different than what the customer originally requested or indicated a preference for.

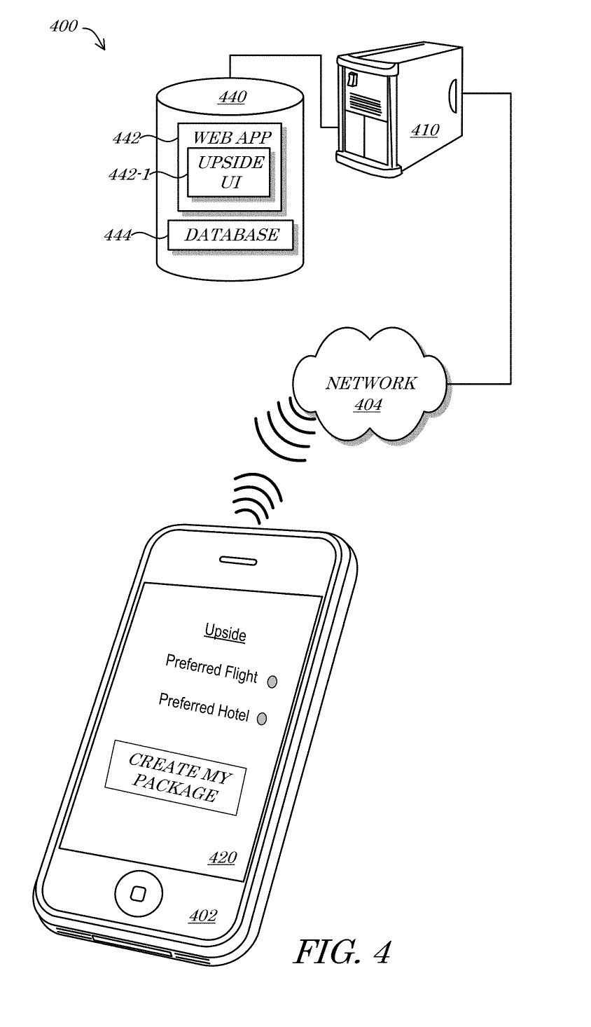

Turning now to FIG. 4, illustrated therein is a mixed block and perspective diagram of system 400, according to some embodiments. In some embodiments, the system 400 may comprise a mobile electronic device 402, a network 404 and/or a server 410. According to some embodiments, mobile electronic device 402 may output a GUI 420 and/or the server 410 may be in communication with a memory device 440 (e.g., storing a web application (“web app”) 442 comprising an Upside web User Interface (UI) (′admin web UI″) 442-1 and/or a data table 444).

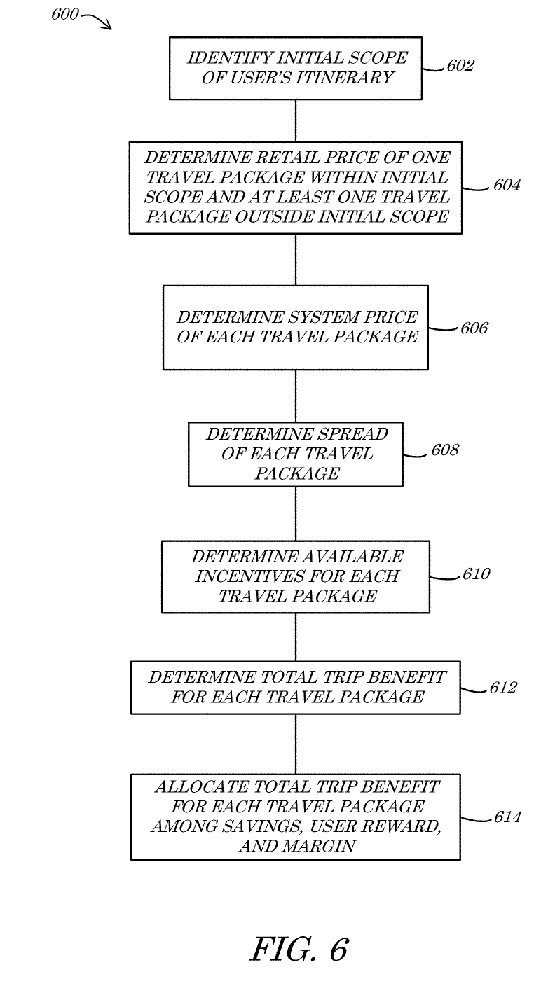

Fewer or more components 402, 404, 410, 420, 440, 442, 442-1, 444 and/or various configurations of the depicted components 402, 404, 410, 420, 440, 442, 442-1, 444 may be included in the system 400 without deviating from the scope of embodiments described herein. In some embodiments, the components 402, 404, 410, 420, 440, 442, 442-1, 444 may be similar in configuration and/or functionality to similarly named and/or numbered components as described herein. In some embodiments, the system 400 (and/or portion thereof) may comprise a discrete/hyper-local navigational program, system, and/or platform programmed and/or otherwise configured to execute, conduct, and/or facilitate the systemic method 600 of FIG. 6 herein, and/or portions thereof.

According to some embodiments, the mobile electronic device 402 runs (i.e., executes) a mobile device software application (“app”) that causes the generation and/or output of the GUI 420. In some embodiments, the app works with or is supported by an iOS operating system executing on the mobile electronic device 402. The app may include, comprise, and/or cause the generation of the GUI 420, which may be utilized, for example, for transmitting and/or exchanging data through and/or via the network 404 (e.g., the Internet). In some embodiments, once the app receives an input from a user of the mobile electronic device 402 (e.g., a request for at least one customized travel package and/or input defining a preferred itinerary or an initial scope of itinerary) the app may output data through an interface for exchanging data and through the network 404. The network 404 routes the data out through an interface for exchanging data to the server 410. According to some embodiments, the app includes specially-programmed software code that includes one or more address identifiers such as Universal Resource Locator (URL) addresses, Internet Protocol (IP) address, etc., that point to and/or reference the server 410 in order to implement one or more embodiment described herein (e.g., to implement a process such as one or more of the processes described with respect to FIG. 3 and/or process 600 of FIG. 6).

In some embodiments, the server 410 may comprise a “cloud app engine” such as a Google® Cloud App Engine executing on a Google® Cloud Platform produced by Google, Inc., a subsidiary of Alphabet Inc., 1600 Amphitheatre Parkway, Mountain View, Calif. 94043. The server 410 may comprise, for example, the web app 442 that supports execution of a Java™ web app. The web app 442 may itself support execution of the Upside web UI 442-1. In some embodiments, the database 440 may comprise a Google® Data Store service available from Google®, Inc. and/or an Amazon® Simple Storage Service (“S3”) available from Amazon® Web Services, Inc. of Seattle, Wash. In some embodiments, server 410 may be an embodiment of the one or more servers comprising travel package server 110 (FIG. 1).

In some embodiments, the database 440 supports a travel package system such as that described with respect to FIGS. 1, 2, 3 and/or 6. In some embodiments, a data storage device (e.g., the example data storage structure 202 of FIG. 2 herein) contains a database, table, and/or file relating information useful for generating a customized travel package for a customer. In some embodiments, the registry contains a lookup table defining various available components for a travel package (e.g., different flights, hotel rooms, incentives usable for generating a package). In some embodiments, the server 410 may communicate with servers or third party organizations (e.g., as described with respect to FIGS. 1, 2 and 3) in order to obtain or receive at least some data useful in generating a travel package (e.g., information regarding availability of flights, hotels, other transportation services and/or current retail rates available for any of the foregoing). In some embodiments, the database 440 stores at least some of the tables or data described with respect to FIG. 2 (e.g., one or more of the tables 204 through 212) and/or FIG. 3 (e.g., qualifying promos 325, qualifying funds 335, traveler history 332 and/or priority suppliers 321).

Turning now to FIG. 5, illustrated therein is illustrated therein is an example process 500 which is consistent with one or more embodiments described herein. It should be noted that the process 500 (as well as process 600 and all processes described herein) is exemplary only and should not be construed in a limiting fashion. For example, additional and/or substitute steps to those illustrated may be practiced within the scope of the present invention(s) and in one or more embodiments one or more steps may be omitted or modified. In one embodiment, the process 500 (or portions thereof) may be performed, for example, by a Travel Package Server 110 (FIG. 1), system 200 (FIG. 2), system 300 (FIG. 3) and/or server 410 (FIG. 4). The process 500 and the process 600 together comprise an example method for generating a plurality of customized travel packages to offer to a user as alternative travel package offers in response to a user requesting such offers and providing first data indicating the user's preferred itinerary or initial scope of an acceptable itinerary.

Referring now to FIG. 5 in particular, illustrated therein is a process 5. It should be noted that process 500 may be preceded by a registration process (not shown) in which a user registers (or is registered) or opens an account with Travel Package Service (although a registration process or opening of an account is not required to request customized travel packages from the Service). During such a registration process, a user may input some information about the user (e.g., name, favorite airlines or hotels, airline frequent flyer club or hotel membership information, contact information for the user etc.). In some embodiments, a profile or record for the user may be initiated and or updated as part of the process 500 (or via an additional process that utilize some of the data obtained or determined via process 500).

It should be noted that a reference to Travel Package Service herein may, unless indicated otherwise, be applicable or interchangeable with a reference to a Travel Package Server 110 (FIG. 1), system 200 (FIG. 2), system 300 (FIG. 3) and/or server 410 (FIG. 4) as described herein. For example, when it is described that data or information is provided to Travel Package Service, it may be interpreted that the data or information is provided to the Travel Package Server 110 (FIG. 1), system 200 (FIG. 2), system 300 (FIG. 3) and/or server 410 (FIG. 4) (e.g., via an interface of an app, such as app 410-1 of FIG. 4).

Turning now to step 502 of process 500, a request for a travel package is received from a user. For example, a user may begin entering data into a user interface of a web page in an online portal of the travel package system or open up the Upside app 442 and begin entering data into the Upside UI 442-1. In some embodiments, the user may actuate a virtual button on a web page or app UI area (e.g., a “Build My Package” or “Get Started” button) to request a travel package. In some embodiments, step 502 may comprise detecting that data is being received for a new session from a user and may not comprise an affirmative request from the user. In some embodiments, step 502 may not be distinct from step 504 and receiving a request for a travel package may comprise receiving data defining a user's preferred itinerary or at least one answer to a question regarding a traveler's upcoming trip.

In step 504, first data defining a user's preferred itinerary for the requested travel package is received. As described with respect to FIG. 3, in some embodiments a user may be presented with a series of questions (e.g., one or two questions per page) that guide the user through a process for determining a user's preferred itinerary or are aimed at defining the boundaries of a user's preferred itinerary or a first scope of the user's itinerary or flexibility. In other embodiments, however, the intake process may be more streamlined and akin to what a user may provide on traditional online travel sites (e.g., a user may be presented with an initial page via which the user enters basic data defining an upcoming trip for which the user would like to request a customized travel package). In one embodiment, the data the user begins entering may comprise data defining the user's preferred travel itinerary for the upcoming trip. For example, in one embodiment the user may enter (i) the origin location for the trip (e.g., city and/or airport the user would like to fly out of); (ii) the destination location for the trip (e.g., the city and/or airport the user would like to fly to); (iii) the arrival date (i.e., the date on which the user would like to arrive at his destination location); (iv) the return date (i.e., the date on which the user would like to return to his origin location); (v) the user's preferred cabin class for the flight (e.g., economy, business or first); (vi) the purpose of the user's trip (e.g., business, leisure or a combination); and (v) other information the system requests when a user is first requesting a travel package (e.g., whether the ticket should be refundable, a preferred location of a hotel in the destination city, a preferred star or other rating of the hotel, whether the user would like to arrange for ground transportation at the destination location (e.g., Uber™, rental car or taxi), how many travelers will be accompanying the user or other information that may be useful to generating a travel package for the user).

In accordance with some embodiments, after a user provides some preliminary information defining his preferred itinerary (e.g., preferred origin location, preferred destination location and dates of trip), the user may be provided with one or more choices for one or more components of the trip that further refine the user's preferences and define the preferred itinerary or initial scope of the user's itinerary. Each such choice may be referred to as a distinct value for the corresponding component (e.g., a first particular available flight may be referred to as a first value or choice for the arrival flight component while a second particular available flight may be referred to as a second value or choice for the arrival flight component). For example, the system may search (e.g., its own proprietary databases or by communicating with one or more third party servers) for available flights and hotels that are within the scope of the itinerary initially provided by the user. For example, the system may present the user with a list of available arrival and return flights as well as a list of available hotels and request that the user select his most preferred flights and hotel (or values for other components of a travel package, depending on the particular components to be included in the travel package).

In some embodiments some preliminary pricing data for the different available value choices for each component of the travel package may also be included (e.g., to allow the user to compare which choices are typically most expensive to which are least expensive based on lowest available retail price data or similar data). For example, the retail prices available through third parties or an indication of a relativity of the prices from one choice to another may be indicated, even if prices for how the system will price these choices if included in a travel package is not yet indicated.

The second set of inputs from the user (e.g., the user's selections of preferred flights and hotel (or values for other components of a travel package, depending on the particular components to be included in the travel package) may, in some embodiments, also be obtained in step 504 and utilized to define the user's preferred itinerary or initial scope of the user's preferred itinerary. In some embodiments the user may not be provided with an opportunity to select specific preferred flights, hotels or other values for the various components of his travel package; rather, the system may attempt to generate a travel package (or plurality of travel package offers) based on the initially provided data only (e.g., origin location, destination location and hotel). The embodiments described herein are not dependent on the level of detail requested or obtained from the traveler as first data in order to define the user's preferred itinerary or initial scope of the user's preferred itinerary and various levels and types of data or input may be requested or obtained from the user in step 504 without departing from the spirit and scope of the embodiments described herein.

In some embodiments, the system may also retrieve or access (e.g., as part of step 504 or as part of another step or process) previously stored data regarding the user's past purchases, offers, itineraries and/or preferences (in embodiments in which the user has an account with the system, is a past customer of the system or is otherwise identifiable as corresponding to an existing record in the system's stored data on users). For example, the system may access the traveler data 208 (FIG. 2) or traveler history 332 (FIG. 3) to obtain such data.

Once the system has the data it is programmed to need as first data defining the user's preferred itinerary, it proceeds to build or generate a plurality of custom travel packages for the user. In process 500, this phase or portion of the process is represented as “A” and represents the more detailed steps illustrated as process 600 (FIG. 6). It should be understood that other embodiments for generating or building one or more travel packages to offer to the player are described herein and process 600 is merely one example embodiment of how this phase of process 500 may be implemented. In accordance with some embodiments, process 500 and/or process 600 (or portions thereof) may be carried out, for example, by the travel package engine 310 (FIG. 3) and/or the travel package engine (220), either of which may be components of travel package server 110 (FIG. 1) and/or travel package server 440 (FIG. 4).

Turning now to FIG. 6, process 600 comprises one example of how a travel package (or a plurality of alternate travel package offers) may be generated for a user in accordance with some of the embodiments described herein. The process 600 may, in some embodiments, be performed by the travel package engine 310 (FIG. 3), the travel package engine 220 (FIG. 2) or a component of either of the foregoing.

As described herein, a travel package offer may, in accordance with some embodiments, include a value for each component of the travel package (e.g., a particular flight for each leg of a trip may each be considered a distinct value for each flight leg component of the trip and a particular hotel may be considered a value for the lodging component of a travel package). As also described herein, particular flights, hotels or values for other components of a travel package may be selected by the system based on data provided by the user that defines the user's preferred itinerary or boundaries of an initial scope of the user's preferred itinerary. In accordance with some embodiments, each travel package may also include the following information: (i) a total price of the travel package (the price the user would need to pay to the system in order to accept the travel package); (ii) an amount of savings to be realized by purchasing the travel package through the system as compared to a sum of retail prices (e.g., a sum of the lowest available retail prices, a sum of the average retail price, etc.) for each variable of the travel package; and (iii) a value of a reward to be provided to the user in exchange for purchasing the travel package (e.g., a value of a monetary reward that the user can then exchange for one or more gift cards usable at partner retailers or another type of monetary value). Referring briefly to FIG. 7 (which is described in more detail below), user interface 700 illustrated therein show one example of how a plurality of packages 705, 710, 715 and 720 (each of which includes this type of information) as they may be output for consideration to the user in accordance with some embodiments.

Referring again to process 600, this example process begins with step 602, in which step the initial scope of the user's itinerary is determined. This step may comprise, for example, receiving the data or inputs obtained from the user in step 504 (process 500, FIG. 5). In some embodiments, this step may further comprise extrapolating information or making assumptions based on the data obtained in step 504.

Then, using the initial scope of the user's itinerary, one travel package within the initial scope of the user's itinerary and at least one travel package outside the initial scope of the user's itinerary is built or generated by the system. For example, the travel package that is within the initial scope of the user's itinerary may simply comprise generating a travel package that consists of the particular flights and hotel selected by the use in step 504. A travel package that is outside the initial scope of the user's preferred itinerary may be generated by changing at least one of the flights and/or the hotel to a different value (e.g., a flight that leaves slightly earlier, slightly later and/or is on a different airline but has a similar departure time or a hotel that is within the same city but in a different neighborhood than that selected by the user). In accordance with some embodiments, the alternate values (e.g., different flights or different hotel) may be selected by the system based on one or more of (i) incentives available from third parties, such as may be stored in the qualifying promotions catalog 325; (ii) feedback or input from other users; (iii) the user's travel history or profile. Generating or building the multiple travel packages may be performed as part of step 602 or as a separate process (e.g., a process that includes steps and considerations such as those described with respect to FIG. 3). For example, in accordance with some embodiments, selecting a value for each component of a given travel package may be based on Priority Suppliers data 321 and/or the smart suppliers filter 323.

Once the travel packages are determined (or as part of generating the travel packages, since in some embodiments, determining pricing and available benefits may be part of the data that is used to generate a travel package), in step 604 the system determines a retail price for each travel package. In accordance with some embodiments, determining a retail price of a given travel package may comprise identifying the lowest available retail price, the average retail price or a typical retail price for each value of each component of the travel package. For example, the system may obtain and compare current retail prices as available on publicly available travel websites such as EXPEDIA™, PRICELINE™, TRIVAGO™ or TRIPADVISOR™ in order to determine how much a user should expect to pay if he/she were to purchase the travel package outside of the system.

In step 606, the system determines the system price for each of the travel packages to be made available to the user. The system price may be based, for example, on rates for the values selected for each of the components as made available to the system by the suppliers of the values (e.g., partner airlines and hotels may provide preferred rates for specific flights or rooms to the system).

In step 608, the SPREAD for each travel package is determined. In accordance with some embodiments, determining the SPREAD of the travel package may be calculated similarly to how the SPREAD_{TRIP} was described above with respect to FIG. 3:

SPREAD_{travel package}=RETAIL_PRICE_{travel package}−SYSTEM_PRICE_{travel package}

In step 610, the available incentives for each travel package are determined. As described above, in some embodiments determining the available incentives may be done earlier in the process, such as if the available incentives are one of the considerations the system uses to select values for particular components when generating a travel package (e.g., if a particular hotel in a user's destination location is offering discounts or subsidies during the days of the user's planned trip, the system may select that hotel for inclusion in one of the travel packages to be offered to the user instead of another hotel that the system may have otherwise selected for the travel package). In accordance with some embodiments, stpe 610 may comprise retrieving or accessing qualifying promotions 325 (FIG. 3) and/or qualifying funds 335 (FIG. 3) or another catalog or record of incentives that may be available for the current user's travel packages.

In step 612, the TOTAL BENEFIT for each travel package is determined (i.e., a monetary value corresponding to the travel package). The INCENTIVES component in the calculation below may, in some embodiments, be a sum of Qualifying Funds and Qualifying Promotions. A similar process for determining a TOTAL BENEFIT was also described above with respect to FIG. 3 and the details described with respect to FIG. 3 will not be repeated herein for purposes of brevity:

SPREAD+INCENTIVES=TOTAL BENEFIT

In some embodiments, an additional value (e.g., an “unexpected reward”, as described with respect to the “post-offer phase” and BLEED description above) may be added when calculating the TOTAL BENEFIT for a given travel package.

In step 612, the TOTAL BENEFIT value may, in accordance with some embodiments, be allocated among one or more of:

(i) the savings associated with the travel package (e.g., as labeled with “your company saves” in FIG. 7), which may indicate the amount of the TOTAL BENEFIT to be allocated to an employer or hirer (or other entity that may pay of the travel package (whether that is the user or another entity) or an entity that will reimburse the user for the travel package) of the user in the form of savings applied to the travel package;

(ii) the reward to be provided to the user as a result of purchasing the travel package (e.g., as labeled “Gift Card earned” in FIG. 7); and

(iii) the margin or profit to be retained by the system (not shown to user).

In some embodiments, a portion of the total benefit may also be allocated to another fund, such as a fund of monetary value to be used to generate future travel packages for this user or another user (e.g., added to the Qualifying Funds 335 (FIG. 3)).

It should be noted that, in accordance with some embodiments, the SPREAD and the savings associated with the travel package may be different amounts or numerical values. For example, since the TOTAL BENEFIT is a sum of the SPREAD and INCENTIVES, the savings over the retail price of the travel package may, in some scenarios, be an amount larger than the SPREAD if some of the INCENTIVES are allocated to it. Or, in other scenarios, the savings to be realized may be less than the SPREAD, depending on the allocation.

In accordance with some embodiments, and as described in more detail above with respect to FIG. 3, the % of the TOTAL BENEFIT allocated to the one or more categories described above and with respect to Table 1 illustrated above may, in some embodiments, may be modified or adjusted by the system. In some embodiments, the % allocation may be modified or adjusted by the user. For example, in some embodiments the user may be provided with a user interface via which the user can adjust the amount of available reward (or % of available reward) for his travel packages (or a particular travel package) to be allocated to savings to be realized by his/her employer vs. as monetary reward for the user. In accordance with some embodiments, step 614 (or another step of process 600 or process 500) may comprise applying the data determined in process 600 to the respective travel packages to be output to the user. For example, the amount of reward determined by applying the appropriate % of the TOTAL BENEFIT to be provided as a reward to the user may be included in a description of a given travel package to be output to the user and the % of the TOTAL BENEFIT to be provided as savings over a retail price of the travel package may also be translated into a monetary amount and included in the description of the travel package.

Once process 600 is completed, the information determined via this process is utilized in the continuation of process 500. Thus, returning to FIG. 5 and process 500, in step 506 the plurality of travel packages (and at least some of the data determined via process 600) is output to the user via a user interface, such that the user is provided with an opportunity to consider the travel packages and select one for purchase. An example of such a user interface and output of a plurality of travel packages is illustrated in FIG. 7, described below. In step 508 a selection of one of the output travel packages is received from the user (this step may also include receiving a payment from the user for the selected package, or may result in a side-process for collecting the payment to be launched). The reward corresponding to the selected and purchased travel package is then added to the reward balance of the user. As described elsewhere herein, in accordance with some embodiments the user can accumulate reward value from different purchased travel packages and the redeem that reward as monetary value (e.g., in the form of gift cards for partner retailers, as selected by the user).

Turning now to FIG. 7, illustrated therein is an example user interface as it may be output to the user after the plurality of travel packages to be offered to the user are determined (e.g., in step 506 of process 500, FIG. 5). In some embodiments, the user interface may comprise a page output as a page of the Upside UI 442-1 of the Web App 442 (FIG. 4), via a user's mobile device. In the example of FIG. 7, four (4) travel packages are offered to a user.

The first travel package 705 may be considered to be a travel package within the initial scope of the user's preferred itinerary and may include values for the package components that were selected by the user during an initial data input phase of requesting the travel package offers (e.g., the user may have selected the particular flights and hotel indicated in travel package 705. The travel package 705 indicates, in area 705b, that (i) the user would be provided with a reward comprising $5 in gift card value, (ii) his/her company would save $43 over the retail price of the travel package and (iii) the total price of the travel package, if the user were to purchase it through the system, is $1509. Is should be noted that although monetary amounts are indicated in US$ denominations, any currency type may be used without departing from the spirit and scope of the embodiments described herein.

The second travel package 710, labeled an “Alternative Package” may be considered to be a travel package outside of the initial scope of the user's preferred itinerary in that it includes a value for a component that was not the value selected by the user, but is rather an alternative value being suggested by the system. In particular, the travel package 710 indicates in area 710a, that the system has selected a different outbound flight for the user (one that is on a different airline and that departs at an earlier time than the flight selected by the user). As indicated in area 710b, the user would be provided with $115 in gift card value (vs. $5 for travel package 705) in exchanging for purchasing travel package 710 and the savings for this travel package would still be $43. Area 710 also shows that the price for this travel package would still be $1509, such that the user would not pay any more in order to obtain the higher gift card reward value. Thus, it appears that the system found one or more incentives for the alternate outbound flight that can be applied to determine a higher TOTAL BENEFIT for travel package 710 than for travel package 705. The system is attempting, in accordance with some embodiments, to provide additional monetary value to the user (in the form of value redeemable for gift cards, in accordance with some embodiments) in exchange for the user expanding his flexibility or the scope of his itinerary to include the alternate outbound flight.

The third travel package 715, also labeled an “Alternative Package” may also be considered to be a travel package outside of the initial scope of the user's preferred itinerary. In particular, the travel package 715 indicates in area 715a that the system has selected a different outbound flight for the user (one that is on a different airline, United Airlines™ vs. Lufthansa™ and that departs at a later time than the flight selected by the user (9:55 pm vs. 5:50 pm)). This alternate flight of travel package 715 is of a shorter duration (7 h 34 m vs. 11 h 10 m) and thus the user would arrive at his destination around the same time (11:30 am vs. 11:00 am). As indicated in area 715b, the user would be provided with $160 in gift card value (vs. $5 for travel package 705 and $115 in travel package 710) in exchanging for purchasing travel package 715 and the savings for this travel package would still be $43. Area 715b also shows that the price for this travel package would still be $1509, such that the user would not pay any more in order to obtain the higher gift card reward value. Thus, it appears that the system found one or more incentives for this other alternate outbound flight that can be applied to determine an even higher TOTAL BENEFIT for travel package 715 than for either travel package 705 or travel package 710. The system is attempting, in accordance with some embodiments, to provide additional monetary value to the user (in the form of value redeemable for gift cards, in accordance with some embodiments) in exchange for the user expanding his flexibility or the scope of his itinerary to include the alternate outbound flight and, perhaps because this flight is significantly later than the user's preferred or selected flight, the user is being offered a relatively higher monetary reward to yet further increase his flexibility.

The fourth travel package 720, also labeled an “Alternative Package” may also be considered to be a travel package outside of the initial scope of the user's preferred itinerary. In particular, the travel package 720 indicates in area 720a that the system has selected a different hotel for the user. As indicated in area 720b, the user would be provided with $165 in gift card value (vs. $5 for travel package 705, $115 for travel package 710 and $160 for travel package 715) in exchanging for purchasing travel package 720 and the savings for this travel package would still be $181. Area 720b also shows that the price for this travel package is lower than any of the other travel packages, $1371. Thus, it appears that the system found one or more incentives for this alternate hotel that can be applied to determine an even higher TOTAL BENEFIT for travel package 720 than for the other travel packages and that price of the travel package is lower (e.g., perhaps the hotel is offering a more favorable preferred rate to the system or another entity, such as a restaurant or other service provider within or close to the hotel, is offering a subsidy for bookings at the hotel). The system is attempting, in accordance with some embodiments, to provide additional monetary value to the user (in the form of value redeemable for gift cards, in accordance with some embodiments) in exchange for the user expanding his flexibility or the scope of his itinerary to include the alternate hotel and, perhaps because this hotel is not within the user's preferred location, the user is being offered a relatively higher monetary reward to yet further increase his flexibility.

Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

For example, as an example alternative to a database structure for storing information, a hierarchical electronic file folder structure may be used. A program may then be used to access the appropriate information in an appropriate file folder in the hierarchy based on a file path named in the program.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### CONCLUSION

While various embodiments have been described herein, it should be understood that the scope of the present invention is not limited to the particular embodiments explicitly described. Many other variations and embodiments would be understood by one of ordinary skill in the art upon reading the present description.

What is claimed is:

1. A system for generating a customized travel package for a user, comprising:
a first system module programmed to generate questions and capture responses from a user in order to identify first data defining a preferred travel itinerary of the user;
a second system module programmed to access an electronic inventory of incentives available for generating customized travel packages, the electronic inventory defining second data;
a third system module programmed to generate a plurality of travel packages based on the first data and the second data to be offered to the user; and
a processor operable with the first system module, the second system module and the third system module to:
(a) receive, via an online website interface and from a first user, a request for a travel package;
(b) determine, by use of the first system module and in response to the request, first data defining a first preferred travel itinerary of the first user and being of a first scope;
(c) determine, by use of the second system module and based on the first data, which incentives in the electronic inventory of incentives are within the first scope;
(d) generate, by use of the third system module and based on the first data determined in (a) and the incentives determined in (b), at least two travel packages to offer to the first user, each travel package being defined by a distinct value for each of: (i) a first variable defining a first component of the travel package; (ii) a second variable defining a second component of the travel package; (iii) a total price of the travel package; (iv) an amount of savings to be realized by purchasing the travel package as compared to a sum of retail prices for each variable of the travel package; and (v) a value of a reward to be provided to the user in exchange for purchasing the travel package; and
(e) output, via an online interface, the at least two travel packages as alternative offers for the user.

2. The system of claim 1, wherein (i) the first component is a lodging selection and the first variable is a particular hotel at which the first user will be booked; and (ii) the second component is an air travel selection and the second variable is a particular flight and airline.

3. The system of claim 1, wherein the amount of savings to be realized comprises an amount of savings to be realized by an employer of the first user who is to fund the travel package.

4. The system of claim 1, wherein the value of reward comprises a monetary incentive to be provided to the first user in addition to the amount of savings and in exchange for the first user's purchase of the corresponding travel package.

5. The system of claim 4, wherein the monetary incentive comprises a value of gift cards to be provided to the first user.

6. The system of claim 5, wherein the value of gift cards can be redeemed with at least one third party retailer that is a partner of the system.

7. The system of claim 5, wherein the monetary incentive is funded by a supplier of at least one component of the travel package to which the monetary incentive corresponds.

8. The system of claim 1, wherein the processor is further operable to:
(f) determine, for each travel package, a difference between the travel package price as offered to the first user by the system and the travel package price if the travel package was purchased for publicly available retail prices offered by at least one other entity, thereby determining a spread value.

9. The system of claim 8, wherein the processor is further operable to:
(g) allocate, for each travel package, at least one of the spread value and a sum of the incentives determined in step (b) among:
(i) the amount of savings to be realized and the value of the reward to be provided to the first user, thereby determining a first value for the amount of savings; and
(ii) a second value defining the value of the reward.

10. The system of claim 9, wherein the processor is operable to allocate the spread value in step (g) based on a preference selection provided by the first user.

11. The system of claim 8, wherein the processor is further operable to allocate, in step (g), a portion of at least one of the spread value and the sum of the incentives determined in step (b) to a profit value to be realized by the system.

12. The system of claim 1, wherein the inventory of incentives comprises monetary incentives that at least one third party is offering in exchange for the system including at least one specified value for at least one of the first component and the second component of a travel package offered to users who request travel packages from the system.

13. The system of claim 1, wherein the inventory of incentives comprises a marketing budget of monetary value stored by the system for use in providing monetary rewards to users to whom travel packages are offered by the system.

14. The system of claim 1, wherein the processor is further operable to:
select, by use of the second system module, at least one of a first variable and a second variable that is outside of the first scope, thereby selecting a non-preferred variable;
select an additional reward value that is determined to be sufficient to reward the user for selecting a travel itinerary outside the first scope, thereby selecting a bonus reward value;
generate a third travel package that includes the non-preferred variable and the bonus reward value; and
output, via the online interface, the third travel package to the user.

15. The system of claim 1, wherein the processor is further operable to select at least one of the first variable and the second variable by assigning, based on the first data, a score to each of a plurality of potential variables that may be used to generate a travel package for the user.

16. The system of claim 1, wherein the processor is further operable to select at least one of the first variable and the second variable by filtering out, based on the first data, a subset of available variables from a plurality of potential variables that may be used to generate a travel package for the user.

17. The system of claim 1, wherein the processor is further operable to determine the first data based at least on one of:
(i) data comprising the user's answers to questions provided in association with the request;
(ii) data received from the user based on previously accepted or rejected travel package offers;
(iii) data derived from previous behavior, purchases or travel history of the user; and
(iv) data derived from purchases, travel history or feedback of other users.
